(19) United States
(12) Patent Application Publication
(10) Pub. No.: US 2012/0026297 A1
(43) Pub. Date: Feb. 2, 2012

(54) IMAGING APPARATUS AND IMAGING METHOD

(76) Inventor: Shunichi Sato, Osaka (JP)

(21) Appl. No.: 13/260,857

(22) PCT Filed: Mar. 30, 2010
(86) PCT No.: PCT/JP2010/002315

§ 371 Date: Sep. 28, 2011

(30) Foreign Application Priority Data
Mar. 30, 2009 (JP) 2009-083276

(51) Int. Cl. H04N 13/02

(52) U.S. Cl. 348/47; 348/E13.074

(57) ABSTRACT

An imaging apparatus includes: a plurality of imaging elements; a plurality of solid lenses that form images on the plurality of imaging elements; a plurality of optical axis control units that control the directions of the optical axes of light that is incident to each of the plurality of imaging elements; a plurality of video processing units that convert photoelectric converted signals output from each of the plurality of imaging elements to video signals; a stereo image processing unit that, by performing stereo matching processing based on the plurality of video signals converted by the plurality of video processing units, determines the amount of shift for each pixel, and generates compositing parameters in which the shift amounts that exceed the pixel pitch of the plurality of imaging elements are normalized to the pixel pitch; and a video compositing processing unit that generates high-definition video by compositing the video signals converted by the plurality of video processing units, based on the compositing parameters generated by the stereo image processing unit.

### TECHNICAL FIELD

The present invention relates to an imaging apparatus and an imaging method.

Priority is claimed based on the Japanese patent application 2009-083276, filed on Mar. 30, 2009, the content of which is incorporated herein by reference.

### BACKGROUND ART

In recent years, digital still cameras and digital video cameras (hereinafter referred to as digital cameras) with high image quality have seen rapid growth in use. Digital cameras are also undergoing advances in compactness and light weight, and compact digital cameras with high image quality are incorporated into cellular telephone handsets or the like. Imaging apparatuses typically used in digital cameras include an imaging element, an image-forming optical system (lens optical system), an image processor, a buffer memory, a flash memory (card-type memory), an image monitor, and electronic circuits and mechanisms that control these elements. The imaging element used is usually a solid-state electronic devices such as a CMOS (complementary metal oxide semiconductor) sensor or a CCD (charge-coupled device) sensor or the like. The distribution of light amount formed as an image on the imaging element is photoelectric converted, and the electrical signal obtained is signal processed by an image processor and a buffer memory. A DSP (digital signal processor) or the like is used as the image processor, and a DRAM (dynamic random access memory) or the like is used as the buffer memory. The imaged image is recorded and stored into a card-type flash memory or the like, and the recorded and stored images can be displayed on a monitor.

In order to remove aberration, the optical system that causes an image to be formed on the imaging element is usually made up of several aspherical lenses. In the case of incorporating an optical zoom function, a drive mechanism (actuator) is required to change the focal length of the combined lens and the distance between the lens and the imaging element. In response to the demand for imaging apparatuses with higher image quality and more sophisticated functionality, imaging elements have increased numbers of pixels and higher definition, and image-forming optical systems are providing lower aberration and improved accuracy, as well as advanced functionality such as zoom functions, autofocus functions, and camera shake compensation. This has been accompanied by the imaging apparatus increasing in size, leading to the problem of difficulty in achieve compactness and thinness.

To solve such problems, proposals have been made to adopt a compound-eye structure in the image-forming optical system, and to use combinations of non-solid lenses such as liquid-crystal lenses and liquid lenses, in order to achieve a compact, thin imaging apparatus. For example, an imaging lens apparatus has been proposed having a constitution including a solid lens array disposed on a plane, a liquid-crystal array, and one imaging element (for example, as in Patent Document 1). This imaging lens apparatus, as shown in FIG. 36, has a lens system having a fixed focal length lens array 2001 and a variable focal length liquid-crystal lens array 2002 having the same number of lenses, and a single imaging element 2003 that images the optical image formed via this lens system. By this constitution, a number of images that is the same as the number of lenses in the lens array 2001 is formed as an image divided on the single imaging element 2003. The plurality of images obtained from the imaging element 2003 are image processed by an arithmetic unit 2004 so as to reconstitute the entire image. Focus information is detected from the arithmetic unit 2004, and each liquid-crystal lens of the liquid-crystal lens array 2002 is driven, via a liquid-crystal drive unit 2005, so as to perform autofocus. In this manner, in the imaging lens apparatus of Patent Document 1, by combining liquid-crystal lenses and solid lenses, the autofocus function and zoom function are implemented, and compactness is also achieved.

An imaging apparatus having one non-solid lens (liquid lens, liquid-crystal lens), a solid lens array, and one imaging element is known (for example, as in Patent Document 2). This imaging apparatus, as shown in FIG. 37, has a liquid-crystal lens 2131, a compound-eye optical system 2120, an imaging compositor 2115, and a drive voltage calculation unit 2142. This imaging apparatus, similar to Patent Document 1, forms a number of images that is the same as the number of lenses in the lens array onto a single imaging element 2105, and reconstitutes the image using image processing. In this manner, in the imaging apparatus of Patent Document 2, by combining one non-solid lens (liquid lens, liquid-crystal lens) and a solid lens array, a compact, thin focus adjustment function is implemented.

In a thin camera with sub-pixel resolution having a sensor array that is an imaging element and an imaging lens array, a method for increasing the resolution of a composited image by changing the relative position offset between the images on two sub-cameras is known (for example, as in Patent Document 3). In this method, an aperture is provided in one of the sub-cameras, the aperture blocking light corresponding to a half-pixel, thereby solving the problem of not being able to improve the resolution depending on the object distance. In Patent Document 3, a liquid-crystal lens, the focal length of which can be controlled by the application of an external voltage, is combined, the focal length is changed, the image formation position and the pixel phase being simultaneously changed, so as to increase the resolution of the composite image. In this manner, in the thin camera of Patent Document 3, by combining an imaging lens array and an imaging element having light-blocking means, a high-resolution composite image is achieved. Also, by combining a liquid lens with the imaging lens array and imaging element, a high-definition composite image is achieved.

In a known image generation method and apparatus (for example, as in Patent Document 4) image information of a plurality of imaging means is used to perform super-resolution interpolation processing with respect to a specific region of a stereo image in which the parallax is small, and to map an image onto a spatial model. Although, in generating a spatial model in the process of generating a viewpoint conversion image from an image imaged by a plurality of imaging means, there is the problem of a lack of definition in the image data that are pasted onto the spatial model at a distance, this apparatus has been solved this problem.
Patent Document 1: Japanese Unexamined Patent Application, First Publication No. 2006-251613
Patent Document 2: Japanese Unexamined Patent Application, First Publication No. 2006-217131
Patent Document 3: Japanese Unexamined Patent Application Publication (Translation of PCT Application) No. 2007-520166
Patent Document 4: Japanese Unexamined Patent Application Publication (Translation of PCT Application) No. 2006-119843

### DISCLOSURE OF INVENTION

### Problem to be Solved by the Invention

However, in the imaging lens apparatuses of Patent Document 1 to Patent Document 3, because the accuracy of adjustment of the relative positioning between the optical system and the imaging element influences the image quality, there is the problem that it is necessary at the time of assembly to adjust the relative positioning between the optical system and the imaging element accurately. In the case in which the relative positioning in adjusted only to mechanical accuracy, a highly accurate non-solid lens or the like is necessary, thereby presenting the problem of high cost. Even if the relative positioning between the optical system and the imaging element is adjusted accurately at the time of assembly of the apparatus, the relative positions of the optical system and the imaging element change with aging and the like, and this could cause deterioration in image quality. Although the image can be improved by readjustment of the positioning, there is the problem that this requires that the same type of adjustment be done as is done at the time of assembly. Additionally, in an apparatus that has an optical system and a large number of imaging elements, because of the large number of adjustment locations, there is the problem of a large amount of work time being required.

In the image generation method and apparatus of Patent Document 4, because a viewpoint conversion image is generated, an accurate spatial model must be generated, but there is the problem that it is difficult to obtain an accurate stereo image from three-dimensional information such as a spatial model. In particular, with a distant image in which the parallax of the stereo image is small, the influences of image intensity variations or noise are felt, and it is difficult with a stereo image to obtain three-dimensional information such as a spatial model accurately. Therefore, even if it is possible to generate an image that is subjected to super-resolution processing over a specific region of a stereo image having small parallax, it is difficult to perform mapping onto a spatial model with good accuracy.

The present invention was made in consideration of the above-noted situation, and has as an object to provide an imaging apparatus and an imaging method that, in order to achieve an imaging apparatus with high image quality, enables easy adjustment of the relative positioning between the optical system and the imaging element, without the need for manual work by a human.

Another object of the present invention is to provide an imaging apparatus and imaging method that, regardless of the parallax of a stereo image, that is, regardless of the object distance, can generate a two-dimensional image having high image quality and high definition.

### Means for Solving the Problem

(1) In first aspect of the present invention, there is provided an imaging apparatus including: a plurality of imaging elements; a plurality of solid lenses that form images on the plurality of imaging elements; a plurality of optical axis control units that control the directions of the optical axes of light that is incident to each of the plurality of imaging elements; a plurality of video processing units that convert photoelectric converted signals output from each of the plurality of imaging elements to video signals; a stereo image processing unit that, by performing stereo matching processing based on the plurality of video signals converted by the plurality of video processing units, determines the amount of shift for each pixel, and generates compositing parameters in which the shift amounts that exceed the pixel pitch of the plurality of imaging elements are normalized to the pixel pitch; and a video compositing processing unit that generates high-definition video by compositing the video signals converted by the plurality of video processing units, based on the compositing parameters generated by the stereo image processing unit.
(2) In addition, in the imaging apparatus according to the first aspect of the present invention, the imaging apparatus may further include; a stereo image noise reduction processing unit that, based on the compositing parameters generated by the stereo image processing unit, reduces the noise of the parallax image used in stereo matching processing.
(3) In addition, in the imaging apparatus according to the first aspect of the present invention, the video compositing processing unit may achieve high definition only in a prescribed region, based on the parallax image generated by the stereo image processing unit.
(4) In second aspect of the present invention, there is provided an imaging method for generating high-definition video including: controlling the directions of the optical axes of light that is incident to each of the plurality of imaging elements; converting the photoelectric converted signals output by the plurality of imaging elements into video signals; by performing stereo matching processing based on the plurality of video signals converted by the plurality of video processing units, determining the amount of shift for each pixel, and generating compositing parameters in which the shift amounts that exceed the pixel pitch of the plurality of imaging elements are normalized to the pixel pitch; and generating high-definition video by compositing the video signals based on the compositing parameters.

### Effect of the Invention

Because the present invention has a plurality of imaging elements, a plurality of solid lenses that form an image on the plurality of imaging elements, and a plurality of optical axis control units that control the optical axes of the respective light incident to the plurality of imaging elements, it is possible to easily perform adjustment of the relative positioning of the optical system and the imaging elements, without the need for manual work by a human, and possible to obtain the effect of achieving an imaging apparatus with high image quality. In particular, because the optical axis of incident light can be controlled so that the light strikes an arbitrary position on an imaging element, the adjustment of the relative positioning between the optical system and the imaging element is performed simply, and it is possible to achieve an imaging apparatus with high image quality. Because the control of the direction of the optical axis is done based on the relative position between the imaging object and the plurality of optical axis control units, it is possible to perform setting of the optical axis to an arbitrary position on the imaging element surface, and possible to achieve an imaging apparatus having a wide range of focus adjustment.

By having a plurality of imaging elements; a plurality of solid lenses that form images on the plurality of imaging elements; a plurality of optical axis control units that control the directions of the optical axes of light that is incident to each of the plurality of imaging elements; a plurality of video processing units that convert photoelectric converted signals output from each of the plurality of imaging elements to video signals; a stereo image processing unit that, by performing stereo matching processing based on the plurality of video signals converted by the plurality of video processing units, determines the amount of shift for each pixel, and generates compositing parameters in which the shift amounts that exceed the pixel pitch of the plurality of imaging elements are normalized to the pixel pitch; and a video compositing processing unit that generates high-definition video by compositing the video signals converted by the plurality of video processing units, based on the compositing parameters generated by the stereo image processing unit; it is possible to generate a high-definition two-dimensional image of high image quality, without regard to the stereo image parallax, that is, without regard to the object distance.

According to the present invention, by further having a stereo image noise reduction processing unit that, based on the compositing parameters generated by the stereo image processing unit, reduces the noise of the parallax image used in stereo matching processing, it is possible to remove noise in the stereo matching processing.

Additionally, according to the present invention, by the video compositing processing unit making high definition only a prescribed region, based on the parallax image generated by the stereo image processing unit, it is possible to achieve high-speed high-definition processing.

### BRIEF DESCRIPTION OF THE DRAWINGS

FIG. 1 is a block diagram showing the constitution of an imaging apparatus according to a first embodiment of the present invention.

FIG. 2 is a detailed configuration diagram of a unit imaging unit of the imaging apparatus according to the first embodiment shown in FIG. 1.

FIG. 3A is a front elevation of a liquid-crystal lens according to the first embodiment.

FIG. 3B is a cross-sectional view of a liquid-crystal lens according to the first embodiment.

FIG. 4 is a schematic representation that describes the function of the liquid-crystal lens used in the imaging apparatus according to the first embodiment.

FIG. 5 is a schematic representation that describes the liquid-crystal lens of the imaging apparatus according to the first embodiment.

FIG. 6 is a schematic representation that describes the imaging element of the imaging apparatus according to the first embodiment shown in FIG. 1.

FIG. 7 is a detailed schematic representation of an imaging element.

FIG. 8 is a block diagram showing the overall constitution of the imaging apparatus shown in FIG. 1.

FIG. 9 is a detailed block diagram of the video processing unit of the imaging apparatus according to the first embodiment.

FIG. 10 is a detailed block diagram of the video compositing processing unit for video processing in the imaging apparatus according to the first embodiment.

FIG. 11 is a detailed block diagram of the control unit for video processing in the imaging apparatus according to the first embodiment.

FIG. 12 is a flowchart describing an example of the operation of the control unit.

FIG. 13 is a descriptive drawing showing the operation of the sub-pixel video compositing high-definition processing shown in FIG. 12.

FIG. 14 is a flowchart describing an example of high-definition judgment.

FIG. 15 is a flowchart describing an example of control voltage change processing.

FIG. 16 is a flowchart describing an example of camera calibration.

FIG. 17 is a schematic representation describing the camera calibration of a unit imaging unit.

FIG. 18 is a schematic representation describing the camera calibration of a plurality of unit imaging units.

FIG. 19 is another schematic representation describing the camera calibration of a plurality of unit imaging units.

FIG. 20 is a schematic representation showing the formation of an image in an imaging apparatus.

FIG. 21 is a schematic representation describing a high-definition sub-pixel.

FIG. 22 is another schematic representation describing a high-definition sub-pixel.

FIG. 23A is a descriptive drawing showing the relationship between the object of imaging (photographed object) and image formation.

FIG. 23B is a descriptive drawing showing the relationship between the object of imaging (photographed object) and image formation.

FIG. 23C is a descriptive drawing showing the relationship between the object of imaging (photographed object) and image formation.

FIG. 24A is a schematic representation describing the operation of the imaging apparatus.

FIG. 24B is a schematic representation describing the operation of the imaging apparatus.

FIG. 25A is a schematic representation for the case in which mounting error causes mounting offset of an imaging element.

FIG. 25B is a schematic representation for the case in which mounting error causes mounting offset of an imaging element.

FIG. 26A is a schematic representation showing the operation of optical axis shift control.

FIG. 26B is a schematic representation showing the operation of optical axis shift control.

FIG. 27A is a descriptive drawing showing the relationship between the imaging distance and optical axis shift.

FIG. 27B is a descriptive drawing showing the relationship between the imaging distance and optical axis shift.

FIG. 28A is a descriptive drawing showing the relationship between the imaging distance and optical axis shift.

FIG. 28B is a descriptive drawing showing the relationship between the imaging distance and optical axis shift.

FIG. 29A is a descriptive drawing showing the image shift effect of depth and optical axis shift.

FIG. 29B is a descriptive drawing showing the image shift effect of depth and optical axis shift.

FIG. 30 is a flowchart describing an example of the generation of parallel translational parameters for each pixel.

FIG. 31 is a descriptive drawing showing an example of the epipolar line for the case of a parallel stereo configuration.

FIG. 32 is a descriptive drawing showing an example of region base matching for the case of a parallel stereo configuration.

FIG. 33 is a descriptive drawing shown an example of a parallax image.

FIG. 34 is a detailed block diagram of the video compositing processing unit for video processing in an imaging apparatus according to a different embodiment.

FIG. 35 is a flowchart describing an example of a noise removal.

FIG. 36 is a block diagram showing the constitution of a conventional imaging apparatus.

FIG. 37 is a block diagram showing the constitution of another conventional imaging apparatus.

### BEST MODE FOR CARRYING OUT THE INVENTION

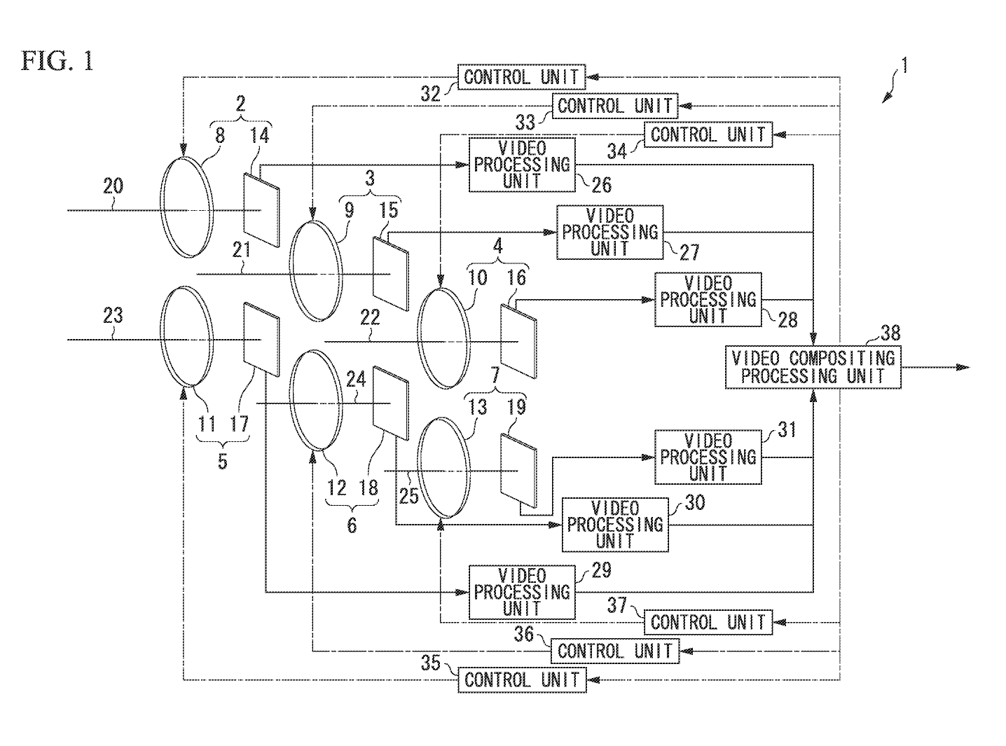

Embodiments of the present invention are described below in detail, with references made to the drawings. FIG. 1 is a functional block diagram showing the overall constitution of an imaging apparatus according to the first embodiment of the present invention. The imaging apparatus 1 shown in FIG. 1 has six sets of unit imaging units, 2 to 7. The unit imaging unit 2 is formed by an imaging lens 8 and an imaging element 14. Similarly, the unit imaging unit 3 is formed by an imaging lens 9 and an imaging element 15. The unit imaging unit 4 is formed by an imaging lens 10 and an imaging element 16. The unit imaging unit 5 is formed by an imaging lens 11 and an imaging element 17. The unit imaging unit 6 is formed by an imaging lens 12 and an imaging element 18. The unit imaging unit 7 is formed by an imaging lens 13 and an imaging element 19. Each of the imaging lenses 8 to 13 forms an image from the light from the photographed object onto the corresponding imaging elements 14 to 19. The reference symbols 20 to 25 shown in FIG. 1 indicate the optical axes of the light incident to each of the imaging elements 14 to 19.

Taking the example of the unit imaging unit 3, the signal flow will now be described. The image formed by the imaging lens 9 is photoelectric converted by the imaging element 15, converting the light signal to an electrical signal. The electrical signal converted by the imaging element 15 is converted to a video signal by the video processing unit 27, in accordance with pre-set parameters. The video processing unit 27 outputs the converted video signal to the video compositing processing unit 38. The video compositing processing unit 38 has input to it video signals converted by the video processing units 26 and 28 to 31 that correspond to the electrical signals output from the other unit imaging units 2 and 4 to 7. In the video compositing processing unit 38, the six video signals imaged by each of the unit imaging units 2 to 7 are composited in synchronization into a single video signal, which is output as high-definition video. In this case, the video compositing processing unit 38 composites high-definition video, based on the results of stereo image processing, to be described later. In the case in which the composited high-resolution video is deteriorated from a pre-set judgment value, the video compositing processing unit 38 generates and outputs a control signal, based on the judgment results, to the six control units 32 to 37. The control units 32 to 37, based on the input control signal, perform optical axis control of each of the corresponding imaging lenses 8 to 13. Then the video compositing processing unit 38 once again performs a judgment of the high-definition video and, if the judgment result is good, the video compositing processing unit 38 outputs the high-definition video, but if the result is bad, it repeats the operation of controlling the imaging lenses 8 to 13.

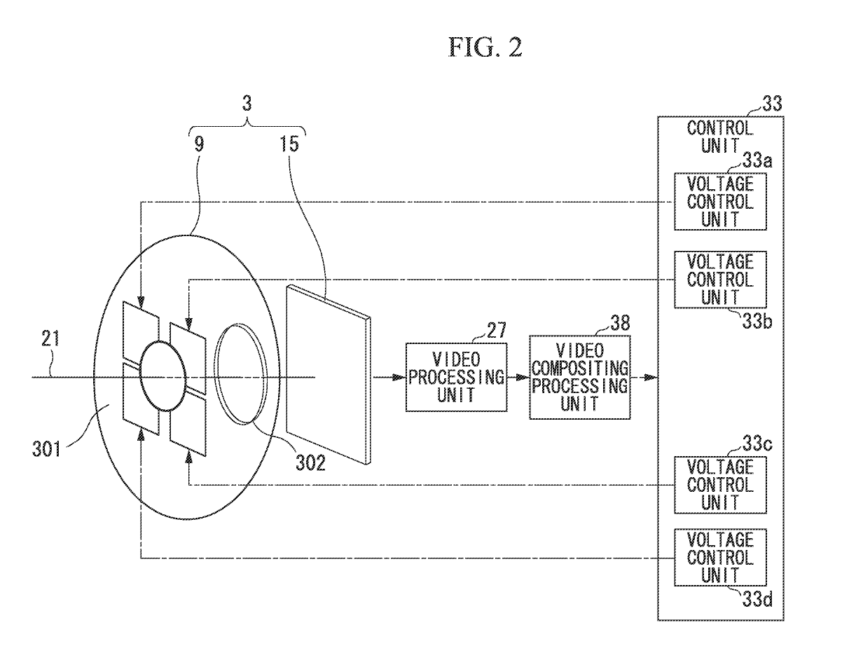

Next, referring to FIG. 2, the detailed constitution of the imaging lens 9 of the unit imaging unit 3 shown in FIG. 1 and the control unit 33 that controls the imaging lens 9 will be described. The unit imaging unit 3 is formed by a liquid-crystal lens (non-solid lens) 301 and an optical lens (solid lens) 302. The control unit 33 is formed by the four voltage control units 33a, 33b, 33c, and 33d, which control the voltages applied to the liquid-crystal lens 301. The voltage control units 33a, 33b, 33c, and 33d, based on a control signal generated by the video compositing processing unit 38, determine the voltages to be applied to the liquid-crystal lens 301, and control the liquid-crystal lens 301. Because the imaging lenses 8 and 10 to 13 and control units 32 and 34 to 37 of the other unit imaging units 2 and 4 to 7 shown in FIG. 1 have the same constitution as the imaging lens 9 and the control unit 33, they will not be described in detail herein.

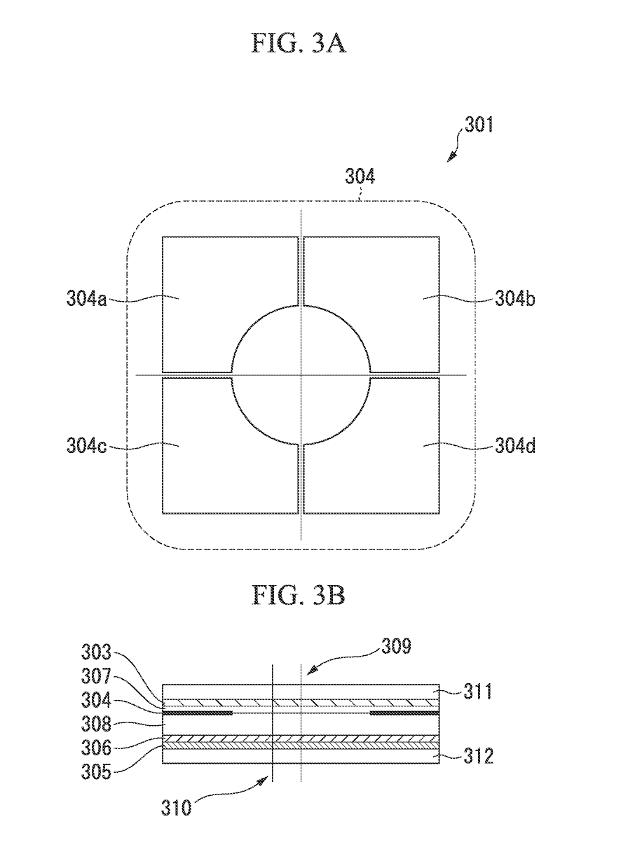

Next, referring to FIG. 3A and FIG. 3B, the constitution of the liquid-crystal lens 301 shown in FIG. 2 will be described. FIG. 3A is a front elevation of the liquid-crystal lens 301 according to the first embodiment. FIG. 3B is a cross-sectional view of the liquid-crystal lens 301 according to the first embodiment.

The liquid-crystal lens 301 in the present embodiment is formed by a transparent first electrode 303, a second electrode 304, a transparent third electrode 305, a liquid-crystal layer 306, a first insulating layer 307, a second insulating layer 308, a third insulating layer 311, and a fourth insulating layer 312.

The liquid-crystal layer 306 is disposed between the second electrode 304 and the third electrode 305. The first insulating layer 307 is disposed between the first electrode 303 and the second electrode 304. The second insulating layer 308 is disposed between the second electrode 304 and the third electrode 305. The third insulating layer 311 is disposed on the outside of the first electrode 303. The fourth insulating layer 312 is disposed on the outside of the third electrode 305.

The second electrode 304 has a circular hole and is formed, as shown in the front elevation of FIG. 3A, to be divided vertically and horizontally into the four electrodes 304a, 304b, 304c, and 304d. Each of the electrodes 304a, 304b, 304c, and 304d can have independently applied it a voltage. Also, the liquid-crystal layer 306 is oriented so that the liquid-crystal molecules are aligned in one direction opposing the third electrode 305, and by applying a voltage among the electrodes 303, 304, and 305 that sandwich the liquid-crystal layer 306, orientation control is performed of the liquid-crystal molecules. In order to accommodate large diameters, transparent glass or the like having a thickness of, for example, approximately several hundred μm is used as the insulating layer 308.

One example of the dimensions of the liquid-crystal lens 301 is indicated below. The diameter of the circular hole in the second electrode 304 is approximately 2 mm. The spacing between the second electrode 304 and the first electrode 303 is 70 μm. The thickness of the second insulating layer 308 is 700 μm. The thickness of the liquid-crystal layer 306 is 60 μm. In the present embodiment, although the first electrode 303 and the second electrode 304 are shown on different layers, they may be formed on one and the same plane. In this case, the first electrode 303 is made to have the shape of a circle having a diameter that is smaller than the circular hole of the second electrode 304, and is disposed at the position of the hole of the second electrode 304, with electrode leads provided in the divided parts of the second electrode 304. When this is done, the first electrode 303 and the electrodes 304a, 304b, 304c, and 304d making up the second electrode can each be independently controlled by a voltage. By adopting this constitution, it is possible to reduce the overall thickness.

Next, the operation of the liquid-crystal lens 301 shown in FIG. 3A and FIG. 3B will be described. In the liquid-crystal lens 301 shown in FIG. 3A and FIG. 3B, a voltage is applied between the transparent third electrode 305 and the second electrode 304, which is an aluminum thin film or the like. Simultaneously, a voltage is also applied between the first electrode 303 and the second electrode 304. By doing this, an electric field gradient with axial symmetry about the central axis 309 of the second electrode 304 having the circular hole can be formed. By the axially symmetrical electrical field gradient around the edge of the circular electrode formed in this manner, the liquid-crystal molecules of the liquid-crystal layer 306 are oriented in the direction of the electrical field gradient. As a result, because of the change in orientation distribution in the liquid-crystal layer 306, the distribution of the index of refraction of abnormal light varies from the center of the round electrode toward the periphery, so that it is possible to cause it to function as a lens. It is possible to freely vary the index of refraction distribution of the liquid-crystal layer 306 according to the manner in which voltages are applied to the first electrode 303 and the second electrode 304, and it is possible to freely control the optical characteristics thereof, including a concave lens or a convex lens.

In the present embodiment, an effective voltage of 20 Vrms is applied between the first electrode 303 and the second electrode 304, an effective voltage of 70 Vrms is applied between the second electrode 304 and the third electrode 305, and an effective voltage of 90 Vrms is applied between the first electrode 303 and the third electrode 305, so that it functions as a convex lens. In this case, the liquid crystal drive voltages (voltages applied between the electrodes) are alternating current waveforms that are sinewaves or rectangular waveforms with a duty cycle of 50%. The voltage value that is applied is expressed as an effective (rms: root mean square) voltage. For example, an alternating current sinewave voltage of 100 Vrms is a voltage waveform having peak values of ±144 V. The frequency of the alternating current voltage used is, for example, 1 kHz. Also, different voltages are applied between the electrodes 304a, 304b, 304c, and 304d of the second electrode 304 and the third electrode 305. By doing this, whereas the application of one and the same voltage would result in the distribution of an index of refraction that is axially symmetrical, the distribution is asymmetrical one with an axis offset with respect to the second electrode central axis 309 having a circular aperture, so that there is the effect of deflection from the direction of direct travel of the incident light. In this case, by appropriately changing the voltages that are applied between the divided second electrode 304 and the third electrode 305, it is possible to vary the direction of deflection of the incident light. For example, if 70 Vrms is applied between the electrode 304a and the electrode 305 and between the electrode 304c and the electrode 305, and 71 Vrms is applied between the electrode 304b and the electrode 305, and between the electrode 304d and the electrode 305, the optical axis position indicated by the reference symbols 309 is shifted to the position indicated by the reference symbol 310. This shift amount is, for example, 3 μm.

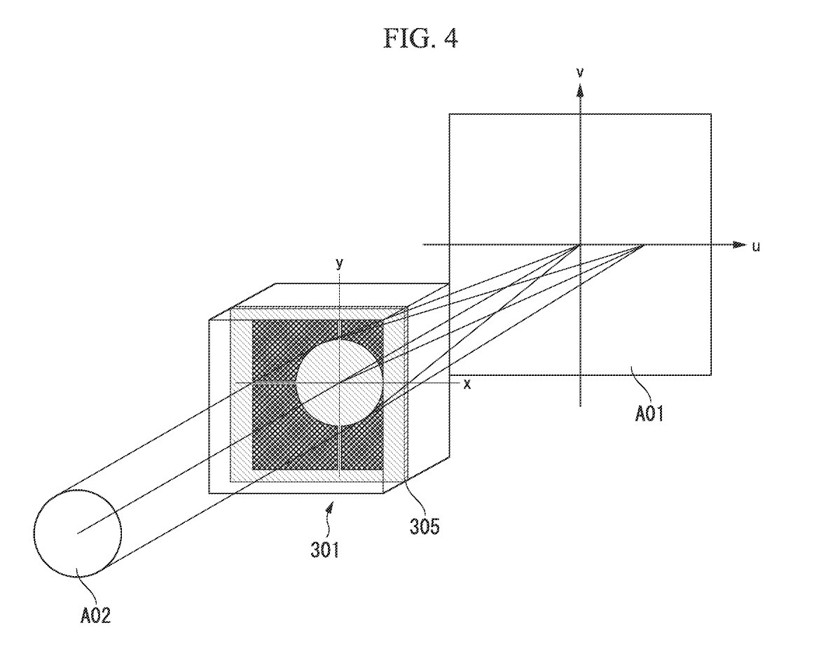

FIG. 4 is a schematic representation describing the optical axis shift function of the liquid-crystal lens 301. As described above, the voltages applied between the electrodes 304a, 304b, 304c, and 304d of the second electrode and the third electrode 305 are controlled separately for the electrodes 304a, 304b, 304c, and 304d. By doing this, it is possible to shift the central axis of the imaging element and the central axis of the index of refraction distribution of the liquid-crystal lens. This is equivalent to a shift of the lens within the xy plane with respect to the imaging element A01 plane. For this reason, it is possible to deflect the light rays entering the imaging element within the u-v plane thereof.

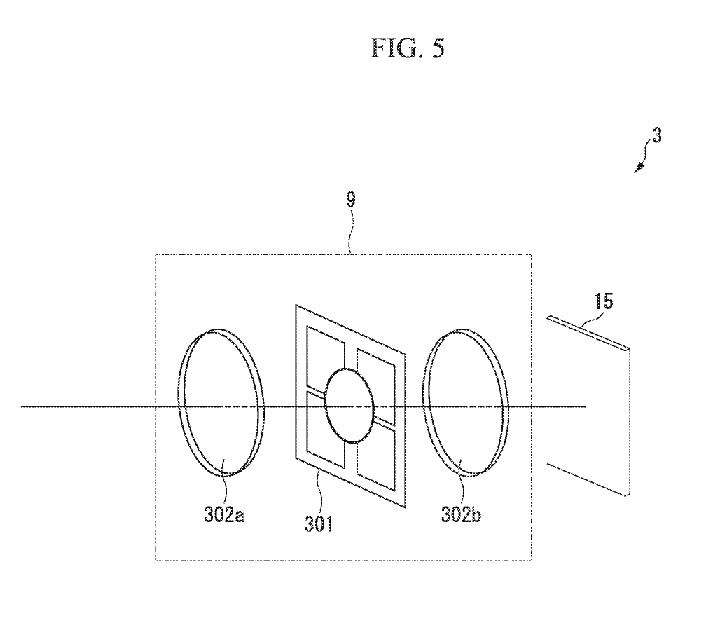

FIG. 5 shows the detailed constitution of the unit imaging unit 3 shown in FIG. 2. The optical lens 302 in the unit imaging unit 3 is formed by the two optical lenses 302a and 302b. The liquid-crystal lens 301 is disposed between the optical lenses 302a and 302b. The optical lenses 302a and 302b are each either single lenses or formed by a plurality of lenses. Light rays incident from the object plane A02 (refer to FIG. 4) are collected by the optical lens 302a disposed on the object plane A02 side of the liquid-crystal lens 301, and strike the liquid-crystal lens 301 as reduced-size spot. When this occurs, the angles of incidence of light rays to the liquid-crystal lens 301 are close to being parallel with respect to the optical axis. The light rays exiting from the liquid-crystal lens 301 are formed as an image on the surface of the imaging element 15 by the optical lens 302b that is disposed on the imaging element 15 side of the liquid-crystal lens 301. By adopting this constitution, it is possible to make the diameter of the liquid-crystal lens 301 smaller, thereby enabling a reduction of the voltage applied to the liquid-crystal lens 301 and an increase the lens effect, while reducing the thickness of the lens by reducing the thickness of the second insulating layer 308.

In the imaging apparatus 1 shown in FIG. 1, the constitution is one in which one imaging lens is disposed with respect to one imaging element. However, a constitution may be adopted in which, in the liquid-crystal lens 301, a plurality of second electrodes 304 are disposed on one and the same substrate, and a plurality of liquid-crystal lenses are integrated as one. That is, in the liquid-crystal lens 301, the hole part of the second electrode 304 corresponds to the lens. Thus, by disposing a plurality of second electrodes 304 in a pattern on one substrate, the hole parts of each second electrode 304 have a lens effect. For this reason, by disposing a plurality of second electrodes 304 on one and the same substrate to match the dispositions of the plurality of imaging elements, it is possible to have a single liquid-crystal lens unit accommodate all of the imaging elements.

In the foregoing description, the number of liquid-crystal layers was one. However, by making the thickness of one layer thin and configuring a liquid-crystal layer as a plurality of layers, it is possible to improve response while maintain approximately the same light-collecting characteristics. This is because the response speed of a liquid-crystal layer deteriorates as the thickness thereof increases. In the case of using a plurality of liquid-crystal layers, by varying the orientation of the polarization between each of the liquid-crystal layers, it is possible to obtain a lens effect for light rays incident to the liquid-crystal lens in all polarization directions. Additionally, although a quad-division was given as an example of the number of electrode divisions, the number of electrode divisions may be changed, in accordance with the desired shift direction.

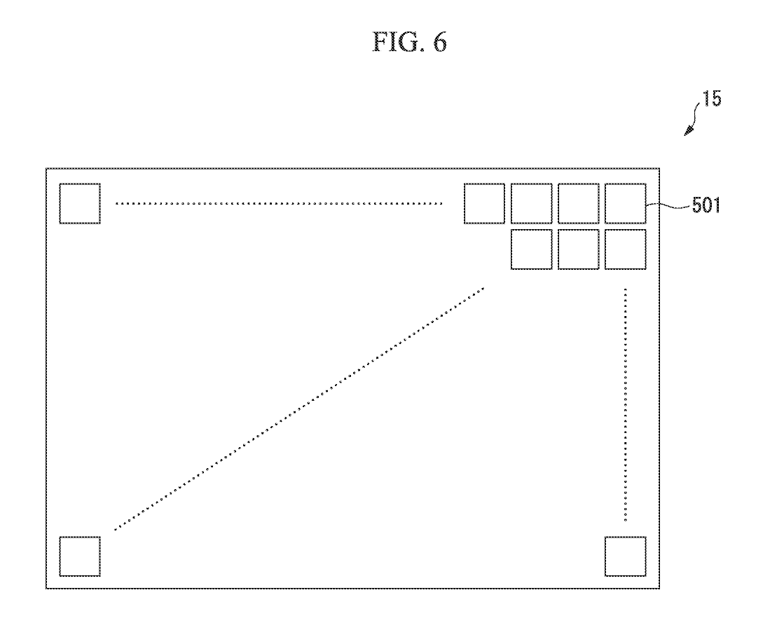

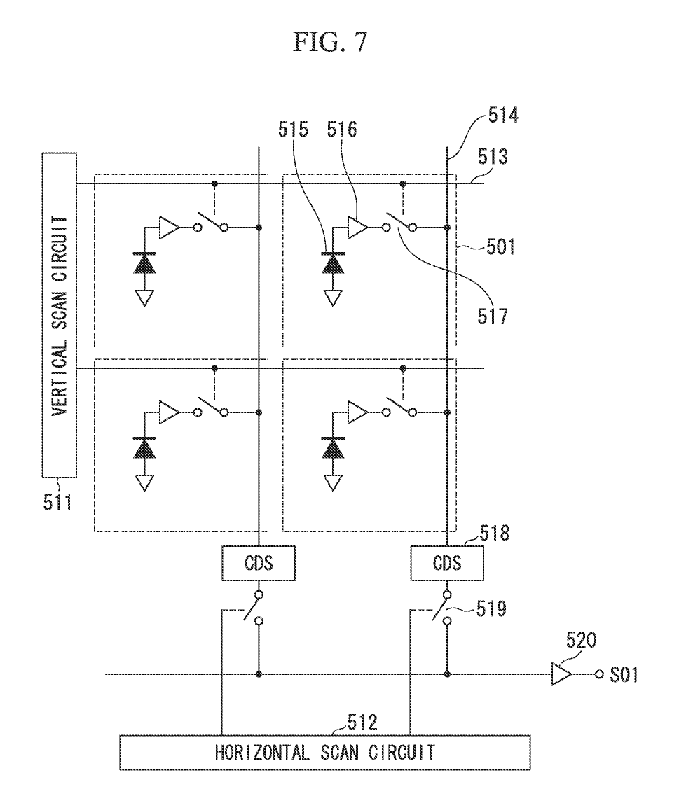

Next, referring to FIG. 6 and FIG. 7, the constitution of the imaging element 15 shown in FIG. 1 will be described. One example of the imaging element that can be used in the imaging apparatus 1 according to the present embodiment is a CMOS imaging element. In FIG. 6, the imaging element 15 is made of the pixels 501, which are arranged in two dimensions. The pixel size of the CMOS imaging element used in the present embodiment is 5.6 μm×5.6 μm, the pixel pitch is 6 μm×6 μm, and the effective number of pixels is 640 (horizontal)×480 (vertical). The term pixel as used herein means the minimum unit for imaging operation performed by the imaging element. One pixel usually corresponds to one photoelectric conversion element (for example, a photodiode). Within the 5.6 μm square pixel size, there is a light-receiving part having a certain surface area (spatial broadening), which converts the pixel to an electrical signal, taking the light intensity obtained by averaging and integrating the light striking the light-receiving part of the pixel. The time for the averaging is controlled by an electronic or mechanical shutter or the like, and the operating frequency thereof generally coincides with the frame frequency of the video signal that the imaging apparatus 1 outputs, for example, 60 Hz.

FIG. 7 shows the detailed constitution of the imaging element 15. In a pixel 501 of the CMOS imaging element 15, an amplifier 516 amplifies the signal electrical charge that is photoelectric converted by a photodiode 515. The signals for each pixel are selected by vertical/horizontal addressing by the vertical scan circuit 511 and the horizontal scan circuit 512 controlling the switches 517, and are extracted as the signal S01, a voltage or current signal, via the CDS (correlated doubling sampling) 518, the switch 519, and the amplifier 520. The switches 517 are connected to a horizontal scan line 513 and a vertical scan line 514. The CDS 518 is a circuit that perform correlated double sampling, and can suppress the 1/f noise of the random noise generated in the amplifier 516 or the like. Pixels other than the pixel 501 have the same constitution and function. Because mass production is possible by the application of CMOS logic LSI manufacturing processes, it is less expensive than a CCD image sensor, which has a high-voltage analog circuit, and the small size of the element means that the power consumption is small, and there is the advantage that, in principle, it is free from smearing and blooming. Although the present embodiment uses a monochrome CMOS imaging element 15, color-capable CMOS imaging elements R, G, and B color filters mounted separately on each pixel may also be used. Using a Bayer structure in which R, G, G, B is repeatedly disposed in a checkered pattern, it is possible to simply implement color with one imaging element.

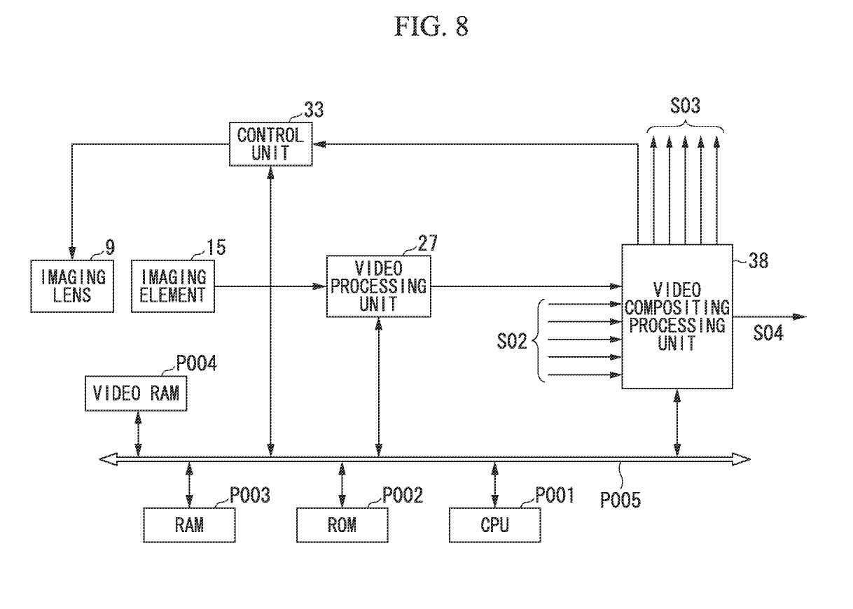

Next, referring to FIG. 8, the overall constitution of the imaging apparatus 1 will be described. In FIG. 8, elements that are the same as in FIG. 1 are assigned the same reference symbols and are not described herein. In FIG. 8, the reference symbol P001 is a CPU (central processing unit) that performs overall control of the operation of the imaging apparatus 1, and there are cases in which this is referred to as a microcontroller. The reference symbol P002 is a ROM (read-only memory) that is made of a non-volatile memory, which stores the CPU P001 program and setting values necessary for various processing units. The reference symbol P003 is a RAM (random-access memory) that stores CPU data temporarily. The reference symbol P004 is a video RAM, which is mainly for the purpose of storing video signals and image signals during the processing thereof, this being an SDRAM (synchronous dynamic RAM) or the like.

Although in FIG. 8 the RAM P003 is provided as program storage for the CPU P001, and the video RAM P004 is provided as image storage, the two RAM blocks, for example, may be integrated into the video RAM P004. The reference symbol P005 is a system bus, to which the CPU P001, the ROM P002, the RAM P003, the video RAM P004, the video processing unit 27, the video compositing processing unit 38, and the control unit 33 are connected. The system bus P005 also connects the later-described inner blocks of each block of the video processing unit 27, the video compositing processing unit 38, and the control unit 33. The CPU P001 acts as a host to control the system bus P005, and bidirectional flow occurs of setting data required for video processing, image processing, and optical axis control.

The system bus P005 is used, for example, when storing into the video RAM P004 an image that is undergoing processing by the video compositing processing unit 38. A bus for image signals, which must have high transfer speed, and a low-speed data bus may be separate bus lines. The system bus P005 has connected to it an interface to the outside such as a USB or a flash memory card that are not shown, and a display drive controller for a liquid-crystal display as a viewfinder.

The video compositing processing unit 38 performs video compositing with respect to the signals S02 input from the other video processing units, outputs the signal S03 to the other control units, and makes an external output as the video signal S04.

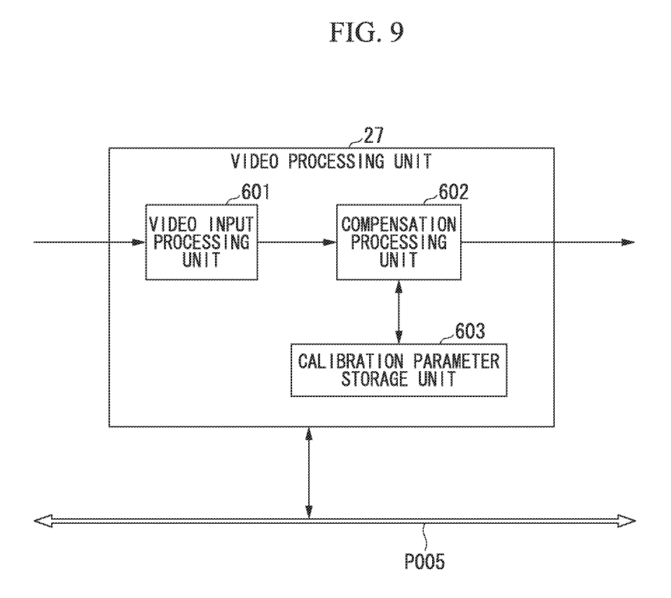

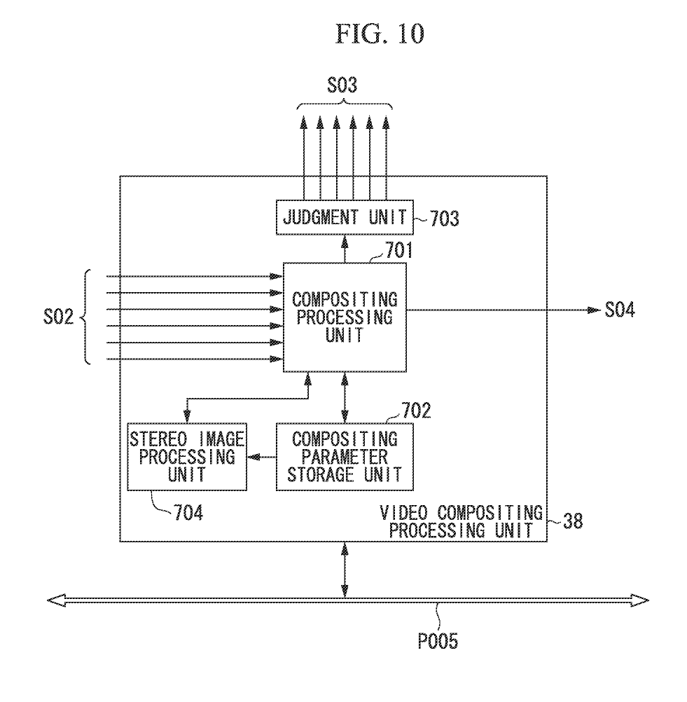

Next, referring to FIG. 9 and FIG. 10, the processing operation of the video processing unit 27 and the video compositing processing unit 38 will be described. FIG. 9 is a block diagram showing the constitution of the video processing unit 27. In FIG. 9, the video processing unit 27 has a video input processing unit 601, a compensation processing unit 602, and a calibration parameter storage unit 603. The video input processing unit 601 captures a video signal from the unit imaging unit 3, and performs signal processing such as, for example, knee processing and gamma processing or the like, and also performs white balance control. The output of the video input processing unit 601 is output to the compensation processing unit 602, and distortion compensation processing, based on calibration parameters obtained by performing a calibration procedure that will be described later. For example, the compensation processing unit 602 calibrates the distortion that is caused by mounting errors of the imaging element 15. The calibration parameter storage unit 603 is a RAM (random-access memory) that stores calibration values. The compensated video signal, which is the output from the compensation processing unit 602, is output to the video compositing processing unit 38. The data stored in the calibration parameter storage unit 603 is updated by the CPU P001 (FIG. 8), for example when the power is applied to the imaging apparatus 1. The calibration parameter storage unit 603 may be made a ROM (read-only memory), into which data is stored that is established by a calibration procedure at the time of shipping from a factory.

The video input processing unit 601, the compensation processing unit 602, and the calibration parameter storage unit 603 are each connected to the system bus P005. For example, the gamma processing characteristics of the video input processing unit 601 are stored in the ROM P002. The video input processing unit 601, in accordance with the program of the CPU P001, receives data stored in the ROM P002 (FIG. 8), via the system bus P005. The compensation processing unit 602 writes image data that is undergoing processing into the video RAM P004 and reads image data undergoing processing from the video RAM P004, via the system bus P005. Although the present embodiment uses a monochrome CMOS imaging element 15, a color CMOS imaging element may be used. In the case of using a color CMOS imaging element, if the imaging element 1 has, for example, a Bayer structure, Bayer compensation processing is performed by the video processing unit 601.

FIG. 10 is a block diagram showing the constitution of the video compositing processing unit 38. The video compositing processing unit 38 has a compositing processing unit 701, a compositing parameter storage unit 702, a judgment unit 703, and a stereo image processing unit 704.

The compositing processing unit 701 performs compositing processing of the imaging results (signals S02 input from the video processing unit) of the plurality of unit imaging units 2 to 7 (FIG. 1). By the compositing processing of the compositing processing unit 701, it is possible to improve the resolution of the image, as will be described below. The compositing parameter storage unit 702 stores the image shift amount data determined from the three-dimensional coordinates between unit imaging units, which are derived by the calibration, which will be described later. The judgment unit 703 generates the signals S03 to the control units, based on the video compositing results. The stereo image processing unit 704 determines the shift amount for each pixel (shift parameter for each pixel) from each of the video images of the plurality of unit imaging units 2 to 7. The stereo image processing unit 704 determines data that is normalized to the pixel pitch of the imaging elements by the imaging conditions (distance).

The compositing processing unit 701 shifts and composites the image based on these shift amounts. The judgment unit 703, by performing a Fourier transform, for example, of the compositing processing results, detects the power of the high-frequency components of the video signal. Let us assume here the case in which the compositing processing unit 701 performs the compositing processing of four unit image units, and assume further that the imaging element is a wide VGA type (854 pixels×480 pixels). Further assume that the video signal S04 that is output by the video compositing processing unit 38 is a High-Vision signal (1920 pixels×1080 pixels). In this case, the frequency range that is judged by the judgment unit 703 is approximately from 20 MHz to 30 MHz. The upper limit of the video frequency band that can be reproduced by the wide VGA video signal is approximately from 10 MHz to 15 MHz. By performing compositing processing by the compositing processing unit 701 using this wide VGA signal, the 20 MHz to 30 MHz components are reproduced. In this case, the imaging element is a wide VGA type. The imaging optical system, which is mainly made of the imaging lenses 8 to 13 (FIG. 1) must have characteristics that do not cause deterioration of the High-Vision signal band.

The video compositing processing unit 38 controls the control units 32 to 37 so that power of the frequency bandwidth of the video signal S04 after this compositing (20 MHz to 30 MHz components as noted in the above example) is maximized. To make a judgment on the frequency axis, the judgment unit 703 performs Fourier transform processing, and makes a judgment with regard to the size of the resulting energy above a specific frequency (for example, 20 MHz). The effect of reproducing the video signal bandwidth exceeding the bandwidth of the imaging elements varies, depending on the phase when sampling is done of the image formed on the imaging elements over a range that is determined by the size of the pixel. The control units 32 to 37 are used to control the imaging lenses 8 to 13 so that this phase is optimal. Specifically, the control unit 33 controls the liquid-crystal lens 301 of the imaging lens 9. The balances of the voltages applied to the divided electrodes 304a, 304b, 304c, and 304d of the liquid-crystal lens 301 is controlled so that the image is shifted on the surface of the imaging element as shown in FIG. 4. In the ideal condition, the result of the control would be that the sampled phase of the imaging results for each of the unit imaging units would be shifted mutually by just ½ of the size of the pixel, either horizontally, vertically, or in an inclined direction. In the case in which this ideal condition is achieved, the energy of the high-frequency components resulting from the Fourier transformation will be maximum. That is, the unit imaging unit 33, by liquid-crystal lens control and by feedback loop that performs a judgment of the resulting compositing processing, performs control so that the energy of the Fourier transformation results is maximum.

In this method of control, the imaging lens 2 and the imaging lenses 4 to 7 (FIG. 1) are controlled via the control units other than the control unit 33, these being the control units 32 and 34 to 37 (FIG. 1), based on the video signal from the video processing unit 27. In this case, the optical axis phase of the imaging element 2 is controlled by the control unit 32, and phases of the optical axes of the other imaging lenses 4 to 7 are also controlled in the same manner. By performing control of the phase over a size that is smaller than the pixel of each imaging element, the offset in phase is averaged over the imaging element and optimized. That is, when an image formed on an imaging element is sampled by a pixel, the sampled phase is ideally controlled so as to achieve higher definition by controlling the optical axis phase. As a result, it is possible to perform compositing of a video signal having high definition and also high image quality. The judgment unit 703 judges the compositing processing results and, if it was possible to composite the video signal with high definition and high image quality, the control value is maintained, and the composing processing unit 701 outputs as video the high-definition high image quality video signal as the signal S04. If, however, it was not possible to composite a video signal with high definition and high image quality, control of the imaging lens is performed once again.

In this case, although because the phase of the image formation of the imaged object and a pixel of the imaging element 1 is smaller than the size of a pixel, it is named and defined as a sub-pixel, there is no actual sub-pixel as a division of a pixel that exists in the structure of the imaging element. The output of the video compositing processing unit 38 is, for example, the video signal S04, which is output to a display (not shown) or output to an image recording unit (not shown), and recorded onto a magnetic tape or into an IC card. The compositing processing unit 701, the compositing parameter storage unit 702, the judgment unit 703, and the stereo image processing unit 704 are each connected to the system bus P005. The compositing parameter storage unit 702 is made of a RAM. For example, the storage unit 702 is updated by the CPU P001 via the system bus P005 when the power is applied to the imaging apparatus 1. Also, the compositing processing unit 701 writes image data that is being processed into the video RAM P004 and reads image data from the video RAM P004 via the system bus P005.

The stereo image processing unit 704 determines the amount of shift for each pixel (shift parameter for each pixel) and data normalized to the pixel pitch of the imaging elements. This is effective in the case of compositing video with a plurality of image shift amounts (shift amounts for each pixel) within one screen of photographed video, specifically, in the case of desiring to photograph video that includes focused objects that are both at a distant and nearby. That is, it is possible to photograph video with a deep depth of field. Conversely, in the case in which, rather than shift amounts for each pixel, a single image shift amount is applied to one screen, it is possible to photograph video with a shallow depth of field.

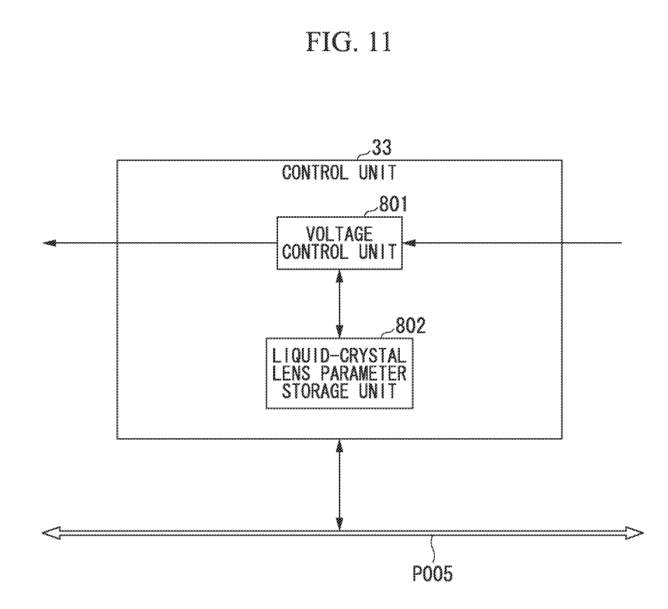

Next, referring to FIG. 11, the constitution of the control unit 33 will be described. In FIG. 11, the control unit 33 has a voltage control unit 801 and a liquid-crystal lens parameter storage unit 802. The voltage control unit 801, in accordance with a control signal input from the judgment unit 703 of the video compositing processing unit 38, controls the voltages applied to each of the electrodes of the liquid-crystal lens 301 of the imaging lens 9. The controlled voltages are determined by the voltage control unit 801, based on the parameter values read out from the liquid-crystal lens parameter storage unit 802. By this processing, the electrical field distribution of the liquid-crystal lens 301 is ideally controlled, and the optical axis is controlled, as shown in FIG. 4. As a result, the captured phase undergoes photoelectric conversion by the imaging element 15 in the compensated condition. By this control, the phase of the pixel is ideally controlled, resulting in an improvement in resolution in the video output signal. If the control results of the control unit 33 are ideal, the energy detected in the results of the Fourier transformation, which is the processing performed by the judgment unit 703, will be maximum. To achieve this condition, the control unit 33 forms a feedback loop with the imaging lens 9, the video processing unit 27, and the video compositing processing unit 38, and performs control of the liquid-crystal lens so that the high-frequency energy is increased. The voltage control unit 801, and the liquid-crystal lens parameter storage unit 802 are each connected to the system bus P005. The liquid-crystal lens parameter storage unit 802 is made of, for example, a RAM, and is updated by the CPU P001 via the system bus P005 when the power is applied to the imaging apparatus 1.

The calibration parameter storage unit 603, the compositing parameter storage unit 702, and the liquid-crystal lens parameter storage unit 802 shown in FIG. 9 to FIG. 11 may be implemented using a single RAM or ROM, by specifying addresses into which storage is done. A part of the addresses in the ROM P002 or the RAM P003 may alternatively be used.

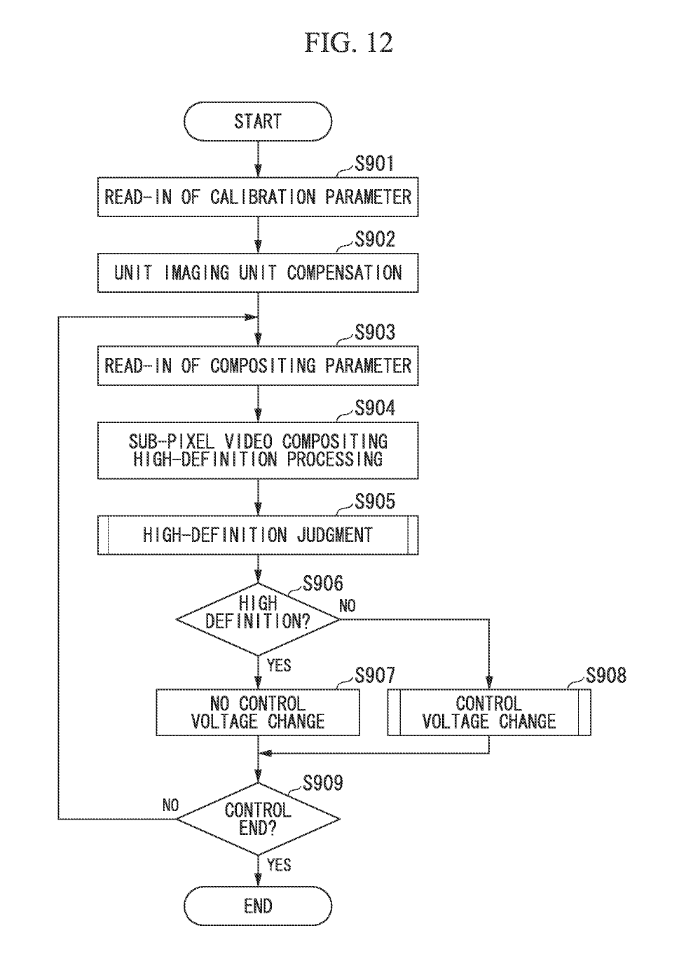

Next, the control operation of the imaging apparatus 1 will be described. FIG. 12 is a flowchart showing the operation of the imaging apparatus 1. This shows an example of using video spatial frequency information in video compositing processing. First, when the CPU P001 gives a command to start control processing, and the compensation processing unit 602 reads in the calibration parameters from the calibration parameter storage unit 603 (step S901). The compensation processing unit 602, based on the read-in calibration parameters, performs compensation processing individually for each of the unit imaging units 2 to 7 (step S902). This compensation removes distortion of the unit imaging units 2 to 7, which will be described later.

Next, the compositing processing unit 701 reads in the compositing parameters from the compositing parameter storage unit 702 (step S903). The stereo image processing unit 704 determines the shift amount for each pixel (shift parameters for each pixel) and data that is normalized to the pixel pitch of the imaging elements. The compositing processing unit 701, based on the read-in compositing parameters and the shift amount for each pixel (shift parameters for each pixel) and on the data normalized to the pixel pitch of the imaging elements, executes sub-pixel video compositing high-definition processing (step S904). As will be described later, the compositing processing unit 701 builds a high-definition image based on information having differing phases in units of sub-pixels.

Next, the judgment unit 703 executes high-definition judgment (step S905) to determine whether there is high definition or not (step S906). The judgment unit 703 internally holds a threshold value for making the judgment, and judges the degree of high definition, outputting the information of the results of the judgment to the corresponding control units 32 to 37. In the case in which high definition is achieved, each of the control units 32 to 37 does not change the control voltage and maintains one and the same value as the liquid-crystal lens parameter (step S907). If, however, the judgment is made at step S906 that high definition is not achieved, the control units 32 to 37 change the control voltages of the liquid-crystal lens 301 (step S908). The CPU P001 manages the control end condition and, for example, makes a judgment as to whether or not the power-off condition of the imaging apparatus 1 is satisfied (step S909). If the control end condition is not satisfied at step S909, the CPU P001 returns to step S903, and repeats the above-noted processing. If, however, the control end condition is satisfied in step S909, the CPU P001 terminates the processing of the flowchart shown in FIG. 12. The control end condition is established beforehand as the number of high definition judgments being, for example, 10 at the time of powering on the imaging apparatus 1, so that the processing of steps S903 to S909 may be repeated the specified number of times.

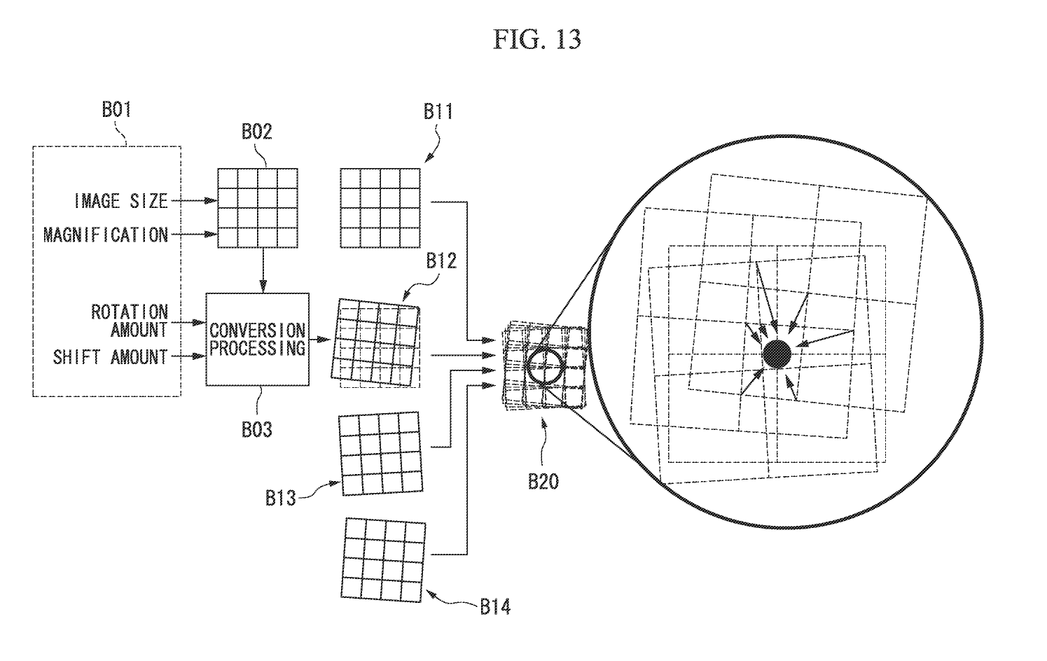

Next, referring to FIG. 13, the operation of the sub-pixel video compositing high definition processing (step S904) will be described. The pixel size, the magnification, the amount of rotation, and the shift amount are compositing parameters B01, which are read out from the compositing parameter storage unit 702 in the compositing parameter read-in processing (step S903). The coordinates B02 are determined based on the image size and magnification of the compositing parameters B01. The conversion calculation B03 is performed based on the coordinates B02, and the amount of rotation and shift amount of the compositing parameters B01.

Let us assume the case in which one high-definition image is obtained from four unit imaging units. The four images B11 to B14 imaged by the individual unit imaging units are overlaid onto one coordinate system B20, using the rotation amount and shift amount parameters. Filter processing is performed by the four images B11 to B14 and by weighting coefficients according to the distance. For example, a cubic (third-order approximation) is used as the filter. The weighting w obtained from a pixel at a distance of d is given as follows.

$$\begin{matrix}w = 1 - 2 \times d 2 + d 3 ( 0 \leq d < 1 ) \\ = 4 - 8 \times d + 5 \times d 2 - d 3 ( 1 \leq d < 2 ) \\ = 0 ( 2 \leq d )\end{matrix}$$

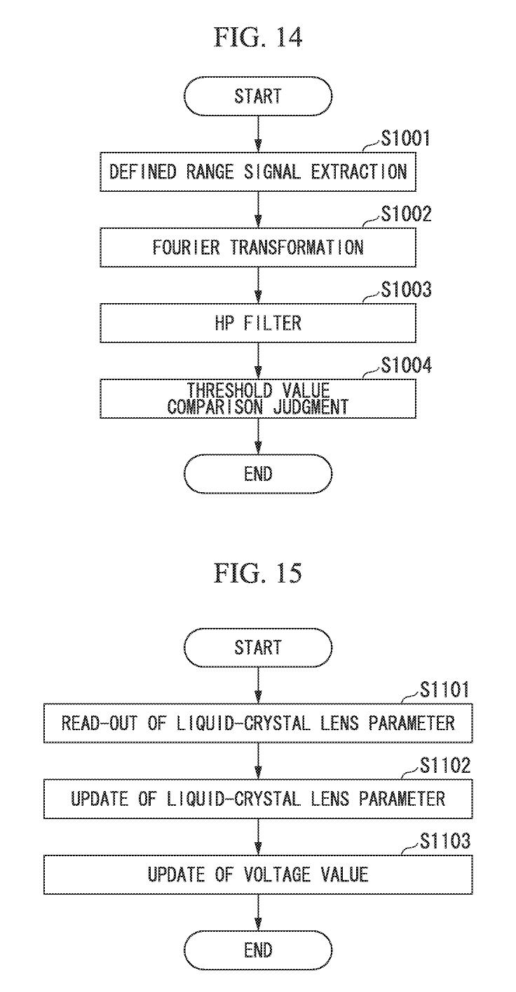

Next, referring to FIG. 14, the detailed operation of the high definition judgment processing (step S905) performed by the judgment unit 703 shown in FIG. 12 will be described. First, the judgment unit 703 extracts the signal within a defined range (step S1001). For example, if the defined range is taken to be one screen in units of frames, one screen of signal is stored beforehand by a frame memory block (not shown). In the case of VGA resolution, for example, one screen would be two-dimensional information of 640×480 pixels. The judgment unit 703 executes Fourier transformation with respect to this two-dimensional information, thereby transforming time-axis information to frequency-axis information (step S1002). Next, a high-frequency range signal is extracted by an HPF (high-pass filter) (step S1003). For example, assume an imaging element 9 for the case of an aspect ratio of 4:3, and a VGA signal (640 pixels×480 pixels) at 60 fps (frames per second) (progressive), and that the video output signal, which is the output of the video compositing processing unit, is a quad-VGA signal. Assume that the limiting resolution of the VGA signal is approximately 8 MHz, and that a 10 MHz to 16 MHz signal is reproduced by the compositing processing. In this case, the high-pass filter has characteristics that pass components of, for example, 10 MHz and higher. The judgment unit 703 performs a judgment (step S1004) by comparing the signals at 10 MHz and higher with a threshold value. For example, in the case in which the DC (direct current) component result of the Fourier transformation is 1, the energy threshold value at 10 MHz and higher is set to 0.5, and the comparison is made with respect to that threshold value.

The above-noted description is for the case in which the Fourier transformation is done using one frame of an image resulting from imaging at a certain resolution. However, if the defined range is in line units (the units of repetition of the horizontal sync or, in the case of a High Vision signal, units of 1920 effective pixels), the frame memory block becomes unnecessary, thereby making it possible to make the size of the circuitry smaller. In this case, for example, in the case of a High Vision signal, the Fourier transformation may be performed repeatedly 1080 times for the number of lines, and an overall threshold value comparison judgment done 1080 times in line units, so as to make a judgment as to the degree of high definition in one screen. The judgment may also be made using the results of a threshold value comparison in units of screens, for plurality of frames. In this manner, by making an overall judgment based on a plurality of judgment results, it is possible to remove the influence of suddenly occurring noise and the like. Also, in the threshold value comparison, although a fixed threshold value may be used, the threshold value may be adaptively changed. The characteristics of the image being judged may be separately extracted, and the threshold value may be changed based on those results. For example, the characteristics of an image may be extracted by histogram detection. Additionally, the current threshold value may be changed by linking it to past judgment results.

Next, referring to FIG. 15, the detailed operation of control voltage changing processing (step S908) executed by the control units 32 to 37 shown in FIG. 12 will be described. This description will use the example of processing operation of the control unit 33, and the control operation of the control units 32 and 34 to 37 being the same. First, the voltage control unit 801 (FIG. 11) reads out the current liquid-crystal lens parameter values from the liquid-crystal lens parameter storage unit 802 (step S1101). The voltage control unit 801 updates the parameter values of the liquid-crystal lens (step S1102). The past history is given as the liquid-crystal lens parameters. For example, with respect to the current four voltage control units 33a, 33b, 33c, and 33d, if the voltage of the voltage control unit 33a is in the process of increasing by 5 V in the past, through the sequence, 40 V, 45 V, 50 V, because of the judgment that neither the past nor the present is high definition, the judgment is made that the voltage should be increased further. Then, the voltage of the voltage control unit 33a is updated to 55 V, while holding the voltage values of the voltage control unit 33b, the voltage control unit 33c, and the voltage control unit 33d constant. In this manner, the values of the voltages applied to the four electrodes 304a, 304b, 304c, and 304d of the liquid-crystal lens are successively updated. The liquid-crystal lens parameter values are updated as the history.

By the above-noted processing, the imaged images of the plurality of unit imaging units 2 to 7 are composited by sub-pixel units, a judgment is made as to the degree of high definition, and control voltage is changed so as to maintain high-definition performance. By doing this, it is possible to achieve an imaging apparatus 1 with high image quality. By applying differing voltages to the divided electrodes 304a, 304b, 304c, and 304d, it is possible to change the sampled phase when sampling is done in imaging element pixel units of the image formed on the imaging elements by the imaging lenses 8 to 13. In the ideal condition of control, the sampled phase of the imaging results for each of the unit imaging units would be shifted mutually by just ½ of the size of the pixel, either horizontally, vertically, or in an inclined direction. The judgment of whether or not the condition is ideal is made by the judgment unit 703.

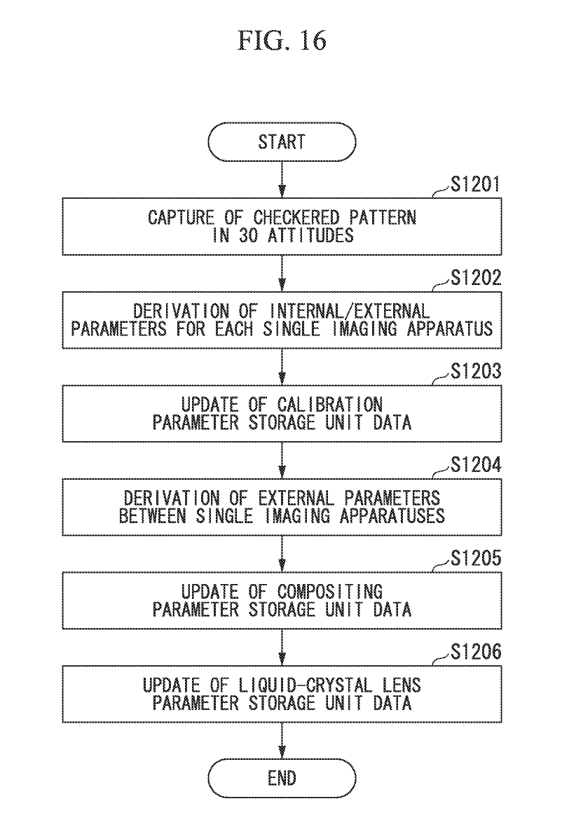

Next, referring to FIG. 16, the processing operation of camera calibration will be described. This processing operation is processing performed, for example, at the time of factory production of the imaging apparatus 1, and is executed by a specific operation, such as pressing a plurality of operating buttons simultaneously when the imaging apparatus is powered on. The camera calibration processing is executed by the CPU P001. First, an operator who is adjusting the imaging apparatus 1 readies a test chart having a known pattern pitch, such as a checkered pattern, and obtains images by photographing the checkered pattern in 30 types of attitudes, while changing the attitude and angle (step S1201). Then, the CPU P001 analyzes these imaged images for each of the unit imaging units 2 to 7, and derives the external parameter values and internal parameter values for each of the unit imaging units 2 to 7 (step S1202). For example, in the case of a general camera model known as a pinhole camera model, the external parameter values are the external parameters that are the six types of rotational and parallel translational information in three dimensions of the attitude of the camera. In the same manner, there are five internal parameters. The processing to derive such parameters is calibration. In a general camera model, the external parameters are the three axis vectors of yaw, pitch, and roll, which indicate the attitude of the camera with respect to the world coordinate system, and the components for the three axes for parallel translation vectors that indicate parallel movement components, for a total of six. There are five internal parameters, the image center (u0, v0) at which the camera's optical axis intersects with the imaging element, the angle of the assumed coordinates on the imaging element, the aspect ratio, and the focal length.

Next, the CPU P001 stores the obtained parameters in the calibration parameter storage unit 603 (step S1203). As noted above, by using these parameters in the compensation processing (step S902 shown in FIG. 12) for the unit imaging units 2 to 7, the camera distortion for each of the unit imaging units 2 to 7 is separately compensated. That is, because there is a case in which the checkered pattern, which should be straight lines, is deformed to curves by the camera distortion and imaged, parameters for the purpose of returning these to straight lines are derived by the camera calibration processing, and the unit imaging units 2 to 7 are compensated.

Next, the CPU P001 derives the parameters between the unit imaging units 2 to 7 as the external parameters between the unit imaging units 2 to 7 (step S1204). Then, the parameters stored in the compositing parameter storage unit 702 and the liquid-crystal lens parameter storage unit 802 are updated (steps S1205 and S1206). These values are used in the sub-pixel video compositing high-definition processing S904 and in the control voltage change 5908.

In this case, the example used is one in which the CPU P001 or microcomputer within the imaging apparatus 1 is given the function of camera calibration. However, a constitution may be adopted in which a separate personal computer is provided and caused to execute the same type of processing on the personal computer, and the obtained parameter only being downloaded into the imaging apparatus 1.

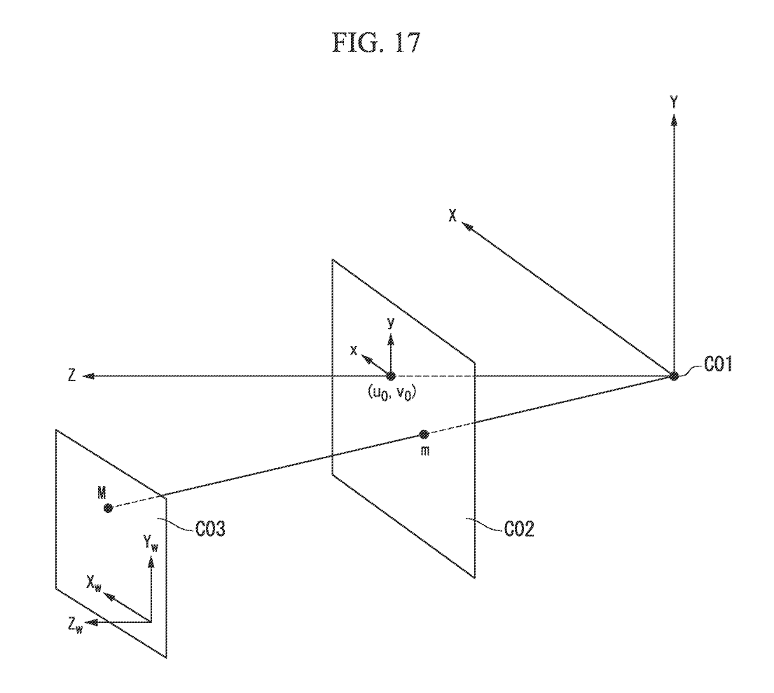

Next, referring to FIG. 17, the principle of camera calibration of the unit imaging units 2 to 7 will be described. In this case, a pinhole camera model such as shown in FIG. 17 is used to show the projection by the camera. In the pinhole camera model, all the light reaching the image plane passes through the pinhole CO 1, which is one point at the center of the lens, and forms as an image at the intersection with the image plane C02. With the point of intersection of the optical axis with the image plane C02 as the origin, the coordinate system with X and Y axes adjusted to the axis of disposition of the camera element is known as the image coordinate system. With the center of the lens of the camera as the origin and the optical axis as the Z axis, the coordinate system having X and Y axes parallel to the X and Y axes is known as the camera coordinate system. The relationship between the three-dimensional coordinates M=[X, Y, Z]^{T} in the world coordinate system (X_{W}, Y_{W}, Z_{W}) which represents the space and the point m=[u, v]^{T} on the image coordinate system (x, y) that is the projection thereof is given by equation (1).

s\tilde{m}=A[R t]\tilde{M} (1)

In equation (1), A is the internal parameter matrix, which is a matrix such as shown below in equation (2).

$$A = [ \begin{matrix}α & γ & {u}_{0} \\ 0 & β & {v}_{0} \\ 0 & 0 & 1\end{matrix} ] \qquad ( 2 )$$

In equation (2), α and β are scaling coefficients that are the products of the size of a pixel and the focal length. (u₀, v₀) is the image center, and γ is a parameter that represents the distortion of the coordinate axes of the image. [R, t] is the external parameter matrix, which is a 4×3 matrix that is made up of a 3×3 rotational matrix R and a parallel movement vector t arranged next to one another.

In the Zhang calibration method, it is possible to determine the internal parameters, the external parameters, and the lens distortion parameters by merely photographing an image (at least three times) while moving a flat plate to which a known pattern has been adhered. In this method, a calibration plane C03 (FIG. 17) is taken as the Z_{w}=0 plane in the world coordinate system and a calibration is performed. The relationship between a point M on the calibration plane C03 shown in equation (1) and the corresponding point m on the image plane, which images that plane, can be rewritten as shown below in equation (3).

$$s [ \begin{matrix}u \\ v \\ 1\end{matrix} ] = A [ \begin{matrix}{r}_{1} & {r}_{2} & {r}_{3} & t ]\end{matrix} [ \begin{matrix}X \\ Y \\ 0 \\ 1\end{matrix} ] = A [ \begin{matrix}{r}_{1} & {r}_{2} & t ]\end{matrix} [ \begin{matrix}X \\ Y \\ 1\end{matrix} ] \qquad ( 3 )$$

The relationship between a point on the plane and a point on the image is the 3×3 homography matrix H, which can be written as follows in equation (4).

s\tilde{m}=H\tilde{M} H=A[r₁ r₂ t] (4)

If one image on the calibration plane C03 is given, one homography matrix H is obtained. If the homography matrix H=[h₁ h₂ h₃] is obtained, equation (5) shown below can be derived from equation (4).

[h₁ h₂ h₃]=λA[r₁ r₂ t] (5)

Because R is a rotational matrix, r₁ and r₂ are perpendicular. For this reason, the following equations (6) and (7), which are two restrictive equations regarding the internal parameters, are obtained.

h₁^{T}A^{-T}A⁻¹h₂=0 (6)

h₁^{T}A^{-T}A⁻¹h₁=h₂^{T}A^{-T}A⁻¹h₂ (7)

A^{-T}A⁻¹ is a 3×3 symmetrical matrix such as shown in equation (8), which includes six unknowns, and it is possible to establish two equations for one H. For this reason, if it is possible to obtain three or more H matrices, it is possible to determine the internal parameters A. Because A^{-T}A⁻¹ has symmetry, the vector b with the arrangement of elements of B as show in equation (8) can be defined as shown in equation (9).

$$\begin{matrix}B = {A}^{- T} {A}^{- 1} = [ \begin{matrix}{B}_{11} & {B}_{12} & {B}_{13} \\ {B}_{12} & {B}_{22} & {B}_{23} \\ {B}_{13} & {B}_{23} & {B}_{33}\end{matrix} ] & ( 8 ) \\ b = {[ \begin{matrix}{B}_{11} & {B}_{12} & {B}_{22} & {B}_{13} & {B}_{23} & {B}_{33}\end{matrix} ]}^{T} & ( 9 )\end{matrix}$$

If the i-th column vector of the homography matrix H is hᵢ=[hᵢ₁ hᵢ₂ hᵢ₃]^{T} (where i=1, 2, 3), hᵢ^{T}Bhⱼ is expressed as shown below in equation (10).

hᵢ^{T}Bhⱼ=vᵢⱼ^{T}b (10)

The Vᵢⱼ in equation (10) is expressed as shown below in equation (11).

vᵢⱼ=[hᵢ₁hⱼ₁ hᵢ₁hⱼ₂+hᵢ₂hⱼ₁ hᵢ₂hⱼ₂ hᵢ₃hⱼ₁+hᵢ₁hⱼ₃ hᵢ₃hⱼ₂+hᵢ₂hⱼ₃ hᵢ₃hⱼ₃]^{T} (11)

By doing this, equation (6) and equation (7) become as shown below in equation (12).

$$[ \begin{matrix}{v}_{12}^{T} \\ {( {v}_{11} - {v}_{22} )}^{T}\end{matrix} ] b = 0 \qquad ( 12 )$$

If n images are obtained, by stacking n of the above-noted equations, it is possible to obtain the following equation (13).

Vb=0 (13)

In this case, V is a 2n×6 matrix. From this, b is determined as the characteristic vector corresponding to the minimum eigen value of V^{T}V. In this case, if n≧3, it is possible to obtain a solution directly for b. If, however, n=2, by setting γ of the internal parameters to γ=0, a solution is obtained by adding the equation [0 1 0 0 0 0]b=0 to equation (13). If n=1 it is only possible to determine two internal parameters. For this reason, a solution is obtained by taking, for example, α and β only as the unknowns, and taking the remaining internal parameters as knowns. If, by determining b, B is determined, the internal parameters of the camera can be calculated from B=μA−TA, using equation (14).

$$\begin{matrix}{v}_{0} = ( {B}_{12} {B}_{13} - {B}_{11} {B}_{23} ) / ( {B}_{11} {B}_{22} - {B}_{12}^{2} ) \\ μ = {B}_{33} - [ {B}_{13}^{2} + {v}_{0} ( {B}_{12} {B}_{13} - {B}_{11} {B}_{23} ) ] / {B}_{11} \\ α = \sqrt{μ / {B}_{11}} \\ β = \sqrt{μ {B}_{11} / ( {B}_{11} {B}_{22} - {B}_{12}^{2} )} \\ γ = - {B}_{12} {α}^{2} β / μ \\ {u}_{0} = γ {v}_{0} / β - {B}_{13} {α}^{2} / μ\end{matrix} \} \qquad ( 14 )$$

If the internal parameters A are determined from this, the following equations (15) can be obtained from equation (5) with regard to the external parameters as well.

$$\begin{matrix}{r}_{1} = λ {A}^{- 1} {h}_{1} \\ {r}_{2} = λ {A}^{- 1} {h}_{2} \\ {r}_{3} = {r}_{1} \times {r}_{2} \\ t = λ {A}^{- 1} {h}_{3} \\ λ = 1 / ‖ {A}^{- 1} {h}_{1} ‖ = 1 / ‖ {A}^{- 1} {h}_{2} ‖\end{matrix} \} \qquad ( 15 )$$

By the non-linear least squares method, taking the parameters obtained thus far as initial values, it is possible, by optimizing the parameters, to obtain the optimal external parameters.

As described above, in the case in which all of the internal parameters are unknown, it is possible to perform a camera calibration by using three or more images obtained by photographing from differing viewpoints with the internal parameters held constant. When this is done, the precision of predicting the parameters is generally higher, the greater is the number of images, and the error increases in the case in which the rotation between the images used for the calibration is small.

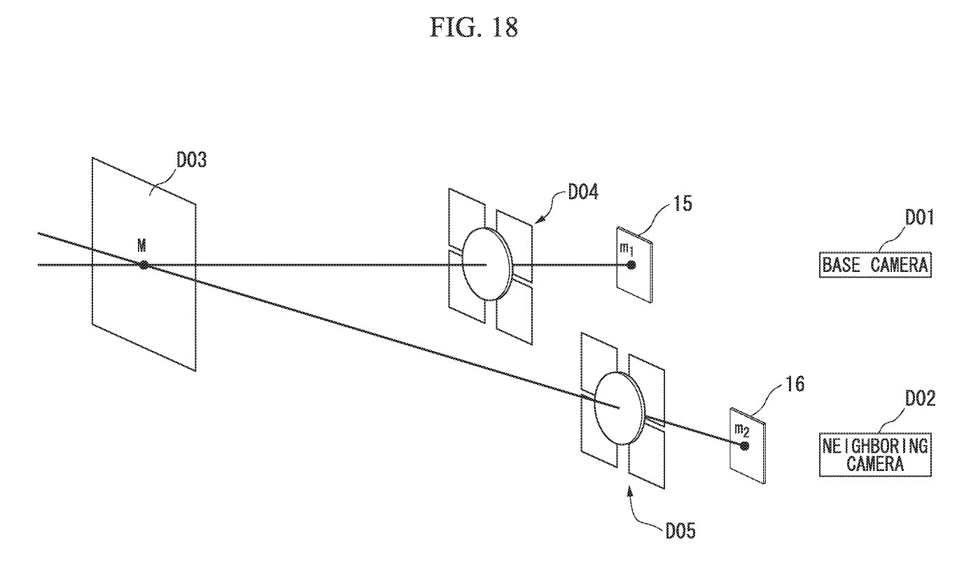

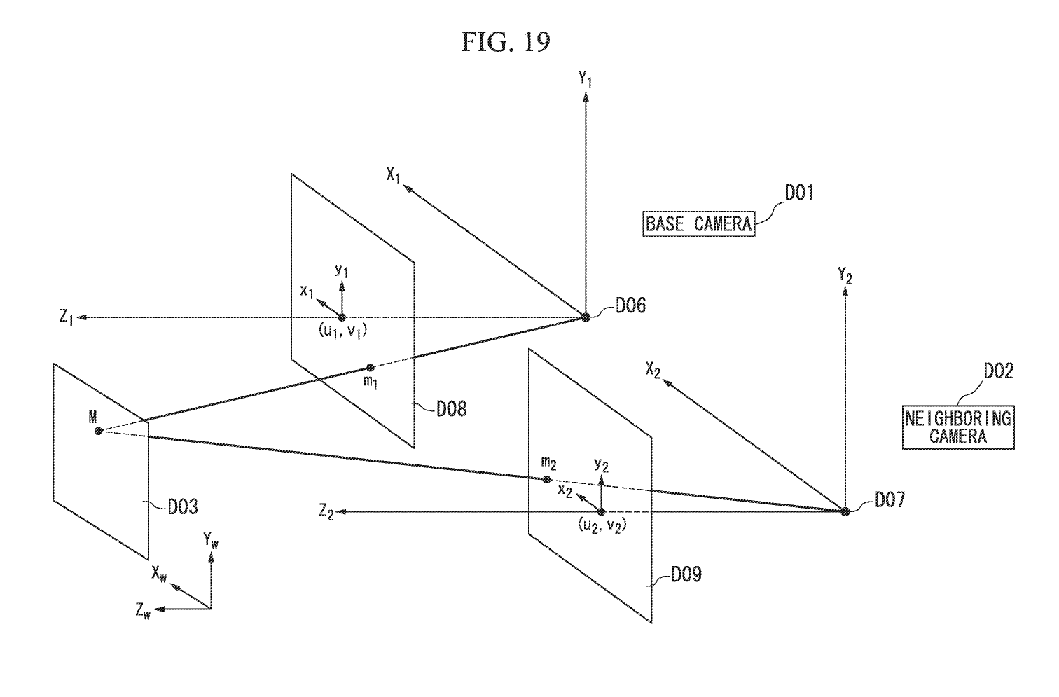

Next, referring to FIG. 18 and FIG. 19, the method will be described whereby an association with a region in which the same region appears in each of the images is determined with sub-pixel accuracy, from the camera parameters representing the position and attitude of the camera (imaging apparatus) determined from the camera calibration.

FIG. 18 shows the case in which the point M on the object plane D03 is projected (photographed) by the imaging element 15 (which will be referred to as the base camera D01) as the reference and the imaging element 16 (which will be referred to as the neighboring camera D02) neighboring thereto onto the point m₁ or the point m₂ on the imaging elements 15 and 16 via the liquid-crystal lenses D04 and D05.

FIG. 19 is a drawing that shows FIG. 18 using the pinhole camera model shown in FIG. 17. In FIG. 19, the reference symbol D06 indicates the pinhole that is the center of the camera lens of the base camera D01, and the reference symbol D07 indicates the center of the pinhole that is the center of the camera lens of the neighboring camera D02. The reference symbol D08 is the image plane of the base camera D01, with Z1 indicating the optical axis of the base camera D01, and the reference symbol D09 is the image plane of the neighboring camera D02, with Z2 indicating the optical axis of the neighboring camera D02.

From the movement and the like of the camera, if the relationship between the point M in the world coordinate system and the point m on the image coordinate system is represented using the center projection matrix P, from equation (1) we have the equation (16) shown below.

m=PM (16)

By using the calculated P, it is possible to represent the relationship of correspondence between a point in a three-dimensional space and a point on a two-dimensional plane. In the constitution shown in FIG. 19, the center projection matrix of the base camera D01 is taken as P₁, and the center projection matrix of the neighboring camera is taken as P₂. The following method is used to determine, from the point m₁ on the image plane D08, the corresponding point m₂ on the image plane D09.

(1) From equation (16), the point M within the three-dimensional space is determined from m₁ by equation (17) given below. Because the center projection matrix P is a 3×4 matrix, the determination is made using the pseudo-inverse matrix of P.

M=(P₁^{T}P₁)⁻¹P₁^{T}m₁ (17)

(2) From the calculated three-dimensional position, the center projection matrix P₂ of the neighboring camera is used to determine the corresponding point m₂ on the neighboring image plane, from equation (18) shown below.

m₂=P₂((P₁^{T}P₁)⁻¹P₁^{T}m₁) (18)

Because the camera parameter P has an analog value, the calculated reference image and corresponding point m₂ on the neighboring image are determined in sub-pixel units. In corresponding point matching using the camera parameters, because the camera parameters have already been determined, there is the advantage that it is only necessary to do a matrix calculation to calculate the corresponding point instantly.

Next, the lens distortion and camera calibration will be described. Although up until this point the description has used a pinhole model that treats the lens as a single point, because an actual lens has a finite size, there are cases that cannot be described with a pinhole model. The compensation of distortion in such cases is done as described below. In the case of using a convex lens, distortion occurs because of the refraction of incident light. The compensation coefficients with respect to such direction of radiation distortion are taken as k₁, k₂, and k₅. In the case in which the lens and the imaging elements are disposed so as to be parallel, tangential direction distortion occurs. The compensation coefficients for this normal direction distortion are taken as k₃ and k₄. These types of distortion are known as distortion aberration. The distortion compensation equations can be expressed as shown below in equation (19), equation (20), and equation (21).

x_{d}=(1+k₁r²+k₂r⁴+k₅r⁶)xᵤ+2k₃xᵤyᵤ+k₄(r²+2xᵤ²) (19)

y_{d}=(1+k₁r²+k₂r⁴+k₅r⁶)yᵤ+k₃(r²+2yᵤ²)+2k₄xᵤyᵤ (20)

r²=xᵤ²+yᵤ² (21)

In this case, (xᵤ, yᵤ) are the image coordinates resulting from imaging by an ideal lens without any distortion aberration, and (x_{d}, y_{d}) are the image coordinates resulting from imaging by a lens having distortion aberration. The coordinate system of these coordinates in both cases is the image coordinate system, with the X and Y axes as described above. Reference symbol r is the distance from the center of the image to (xᵤ, yᵤ). The image center is established by the internal parameters u₀, v₀ described above. Assuming the above-noted model, if the coefficients k₁ to k₅ and the internal parameters are determined by calibration, the difference in image-formation coordinates between the conditions of having and not having distortion is determined, thereby enabling the compensation of the distortion caused by the actual lens.

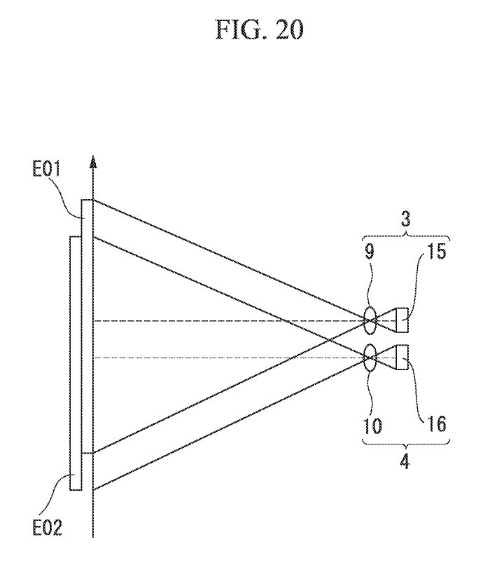

FIG. 20 is a schematic representation showing the imaging occurring in the imaging apparatus 1. The unit imaging unit 3 constituted by the imaging element 15 and the imaging lens 9 forms an image of the imaging range E01. The unit imaging unit 4 constituted by the imaging element 16 and the imaging lens 10 forms an image of the imaging range E02. Substantially the same imaging range is imaged by the two unit imaging units 3 and 4. In the case, for example, in which the distance of disposition spacing of the imaging elements 15 and 16 is 12 mm, the focal length of the unit imaging units 3 and 4 is 5 mm, the distance to the imaging range is 600 mm, and the optical axes of the unit imaging units 3 and 4 are parallel, the differing area between the imaging ranges E01 and E02 is approximately 3%. In this manner, the same part is imaged and high definition processing is performed by the compositing processing unit 38.

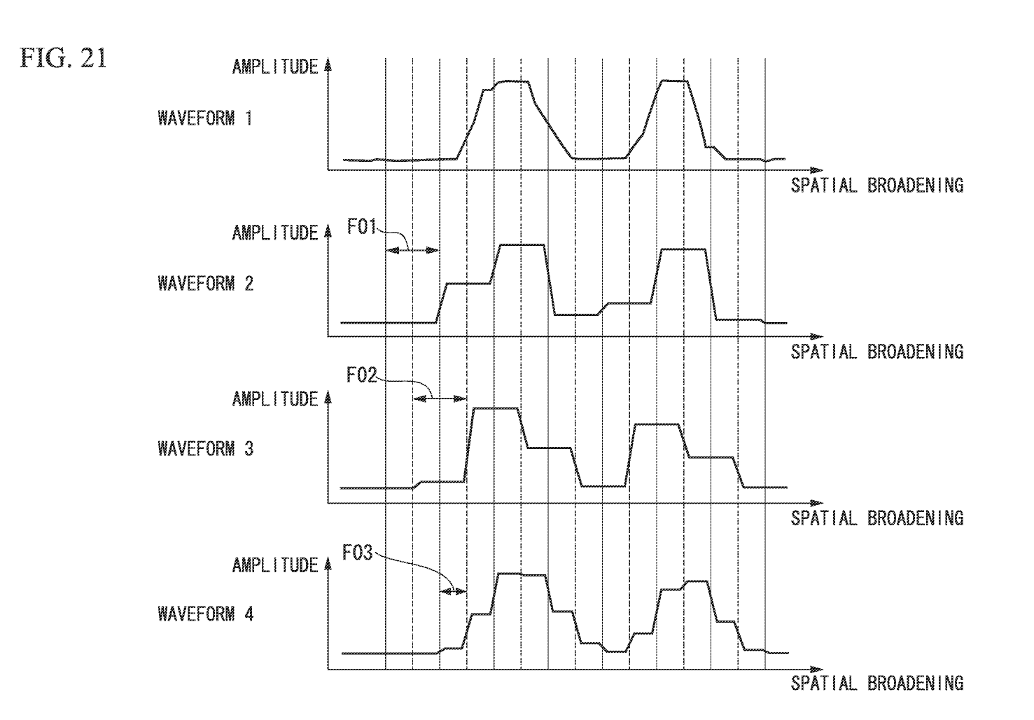

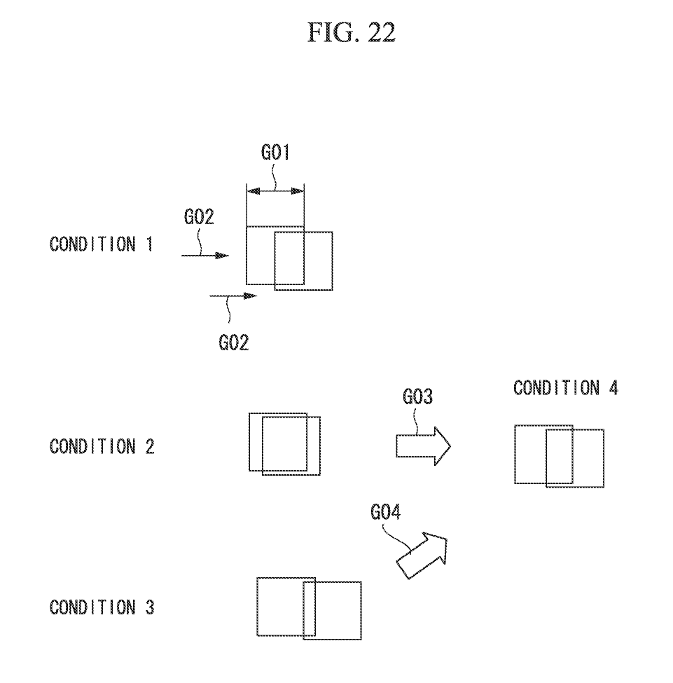

Next, referring to FIG. 21 and FIG. 22, the achievement of high definition in the imaging apparatus 1 will be described.

Waveform 1 in FIG. 21 shows the contour of the photographed object. Waveform 2 in FIG. 21 shows the result of imaging with a single imaging apparatus. Waveform 3 in FIG. 21 shows the results of imaging with a single imaging apparatus. Waveform 4 in FIG. 21 shows the output of the compositing processing unit.

In FIG. 21, the horizontal axis shows a spatial broadening. This spatial broadening shows both the case of the actual space and of virtual spatial broadening occurring in the imaging element. Because these can be mutually converted and transformed using the external parameters and the internal parameters, they have the same meaning. If these are treated as being the video signal sequentially read out from the imaging elements, the horizontal axis in FIG. 21 would be the time axis. In this case as well, in the case of a displaying onto a display, because spatial broadening is recognized by the eye of an observer, even for the case of the time axis of the video signal, the meaning is the same as spatial broadening. The vertical axis in FIG. 21 is amplitude or intensity. Because intensity of light reflected from the object is photoelectric converted by the pixel of the imaging elements and output as a voltage level, this may be treated as being an amplitude.

The waveform 1 in FIG. 21 is the contour of the object in the actual space. This contour, that is, the intensity of reflected light from the object, is integrated by the broadening of the pixel of the imaging element. For this reason, the unit imaging units 2 to 7 capture waveforms such as the waveform 2 in FIG. 21. An example of the integration is that performed by using an LPF (lowpass filter). The arrows F01 in the waveform 2 in FIG. 21 show the broadening of the pixel of the imaging element. The waveform 3 in FIG. 21 is the result of imaging with the different unit imaging units 2 to 7, which is the integration of light by the pixel broadening shown by the arrows F02 in the waveform 3 of FIG. 21. As shown by the waveform 2 and the waveform 3 in FIG. 21, the contour (profile) of reflected light smaller than the broadening that is determined by the resolution (pixel size) of the imaging element cannot be reproduced by the imaging element.

However, a feature of the present embodiment is the imparting of an offset in the phase relationship between the two wavelengths 2 and 3 of FIG. 21. By having this type of offset, capturing light, and performing optimal compositing by the compositing processing unit, it is possible to reproduce the contour shown by the waveform 4 in FIG. 21. As is clear from the waveforms 1 to 4 of FIG. 21, the waveform 4 best reproduces the contour of the waveform 1 of FIG. 21, this being equivalent to the performance of the pixel size of the imaging element that corresponds to the width of the arrows F03 in the waveform 4 of FIG. 21. In the present embodiment, using a plurality of non-solid lenses such as liquid-crystal lenses and unit imaging units constituted by imaging elements, it is possible to obtain a video output that exceeds the resolution limit with the above-described averaging (integration using an LPF).

FIG. 22 is a schematic representation showing the relative phase relationship between two unit imaging units. In the case in which high definition is achieved by downstream image processing, it is desirable that relative relationship of the sampling phase by the imaging elements be at uniform intervals. The term sampling is synonymous with sampling, and refers to the extraction of an analog signal at discrete positions. In FIG. 22, it is assumed that two unit imaging units are used. For this reason, the phase relationship, shown as condition 1 in FIG. 22, is ideally a phase relationship of a 0.5 times the pixel size G01. As shown by the condition 1 in FIG. 22, the light G02 strikes each of the two unit imaging units.

However, because of the relationship to the imaging distance and the assembly of the imaging apparatus 1, there are cases resulting in the condition 2 of FIG. 22 and the condition 3 of FIG. 22. In such cases, if image processing is done using only the video signal after averaging, it is not possible to reproduce a signal that has been averaged after already being in the phase relationship of the condition 2 and condition 3 of FIG. 22. Given this, it is necessary to control the phase relationship of the condition 2 or the condition 3 of FIG. 22 with high accuracy, as shown by condition 4 of FIG. 22. In the present embodiment, this control is achieved by an optical axis shift using a liquid-crystal lens as shown in FIG. 4. By the above-noted processing, because it is possible to maintain the ideal phase relationship at all times, it is possible to provide an optimal image to the observer.

The one-dimensional phase relationship of FIG. 22 was described above. For example, using four unit imaging units, by making one-dimensional shifts in each in the horizontal, vertical and 45-degree inclined directions, the operations of FIG. 22 enable phase control in a two-dimensional space. Alternatively, for example, two unit imaging units may be used, performing two-dimensional phase control (horizontal, vertical, and horizontal+vertical) of one of the unit imaging units with respect to one unit imaging unit that is taken as a reference, so as to achieve phase control in two dimensions.

Assume, for example, that four unit imaging units are used, and that substantially the same imaged object (photographed object) is imaged to obtain four images. Taking one of the images as a reference, by performing a Fourier transformation on each of the images, judging the characteristic points on the frequency axis, calculating the rotation amount and shift amount with respect to the reference image and using the rotation amount and shift amount to perform interpolation filtering processing, it is possible to obtain a high definition image. For example, if the number of pixels of imaging elements is VGA (640×480 pixels), a quad-VGA (1280×960 pixel) high definition image is obtained by four VGA unit imaging units.

In the above-described interpolation filtering, the cubic (third-order approximation) method, for example, is used. This is processing that applies weighting in accordance with the distance to the interpolation point. Although the resolution limit of the imaging apparatus 1 is VGA, the imaging lens has the ability to pass the quad-VGA bandwidth, and the quad-VGA band components that are above VGA are imaged with VGA resolution as wrap-around distortion (aliasing). By using this wrap-around distortion and performing video compositing processing, the high-frequency quad-VGA band components are reproduced.

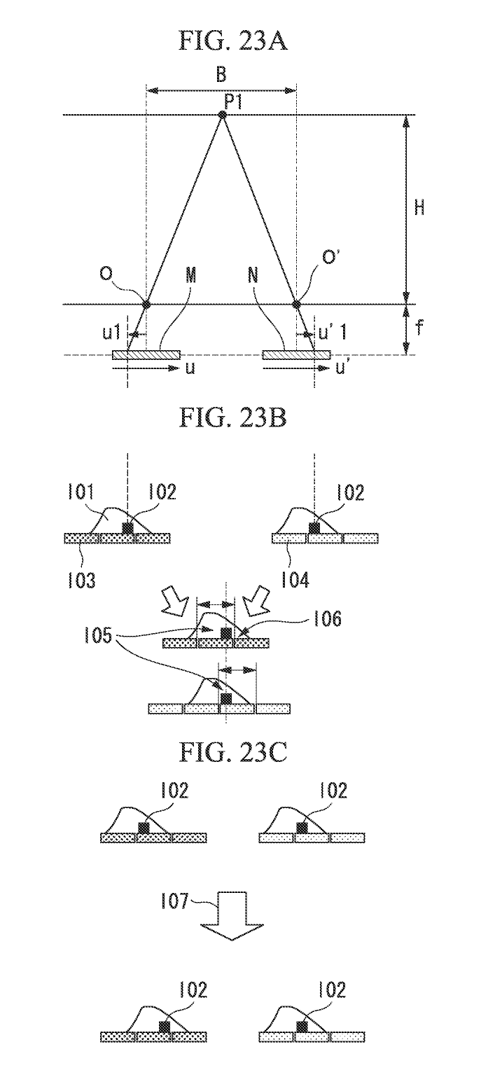

FIG. 23A to FIG. 23C are drawings showing the relationship between the imaged object (photographed object) and the formed image.

In FIG. 23B, the reference symbol 101 indicates overall view of the light intensity distribution, reference symbol I02 indicates a point corresponding to P1, reference symbol 103 indicates a pixel of the imaging element M, and reference symbol 104 indicates a pixel of the imaging element N.

In FIG. 23B, as shown by the reference symbol 105, the amount of light flux averaged by the pixel differs with the phase relationship between the corresponding point and the pixel, and this information is used to achieve high resolution. Also, as shown by the reference symbol 106, image shifting is done to cause overlap of corresponding points. In FIG. 23C, the reference symbol I02 indicates the point corresponding to P1. In FIG. 23C, as shown by the reference symbol 107, optical axis shift is performed by the liquid-crystal lens.

In FIG. 23A to FIG. 23C, a pinhole model that ignores lens distortion is used as a base. For an imaging apparatus having a small amount of lens distortion, this model can be used as a description, and can explain only geometric optics. In FIG. 23A, P1 is the imaged object, which is at the imaging distance H from the imaging apparatus. The pinholes O and O′ correspond to the imaging lenses of two unit imaging units. FIG. 23A is a schematic representation showing the case in which two unit imaging units of the imaging elements M and N image one image. FIG. 23B shows the condition in which the image P1 is formed on a pixel of an imaging element. The phase of the pixel and the formed image are established in this manner. This phase is determined by the mutual positional relationship between the imaging elements (baseline length B), the focal distance f, and the imaging distance H.

That is, depending upon the mounting accuracy of the imaging elements, there are cases in which there is a difference from the designed value, and this can differ depending upon the imaging distance. In this case, for some combination, as shown in FIG. 23C, there are cases in which there is mutual coincidence in the phases. The light intensity distribution image presented in FIG. 23B shows in schematic form the intensity of light with respect to a certain broadening. With respect to input of light such as this, averaging is done over the range of the broadening of the pixel in the imaging element. As shown in FIG. 23B, in the case in which different phases are captured by two unit imaging units, one and the same light intensity distribution is averaged with differing phases. For this reason, it is possible to reproduce the high-frequency components (for example, if the imaging elements are VGA resolution, high-frequency components exceeding the VGA resolution) by downstream compositing processing. In this case, because two unit imaging units are used, the ideal position offset is 0.5 pixel.

However, if the phases coincide as shown in FIG. 23C, the information that each of the mutual imaging elements captures is the same, and it is impossible to achieve high resolution. Given this, by controlling to the optimal condition of the phase by optical axis shifting, such as shown in FIG. 23C, it is possible to achieve high resolution. The optimal condition is achieved by performing the processing shown in FIG. 14. It is desirable that the phase relationship is such that the phase of the unit imaging units that are used is at a uniform interval. Because the present embodiment has an optical axis shift function, such an optimal condition can be achieved by voltage control from outside.

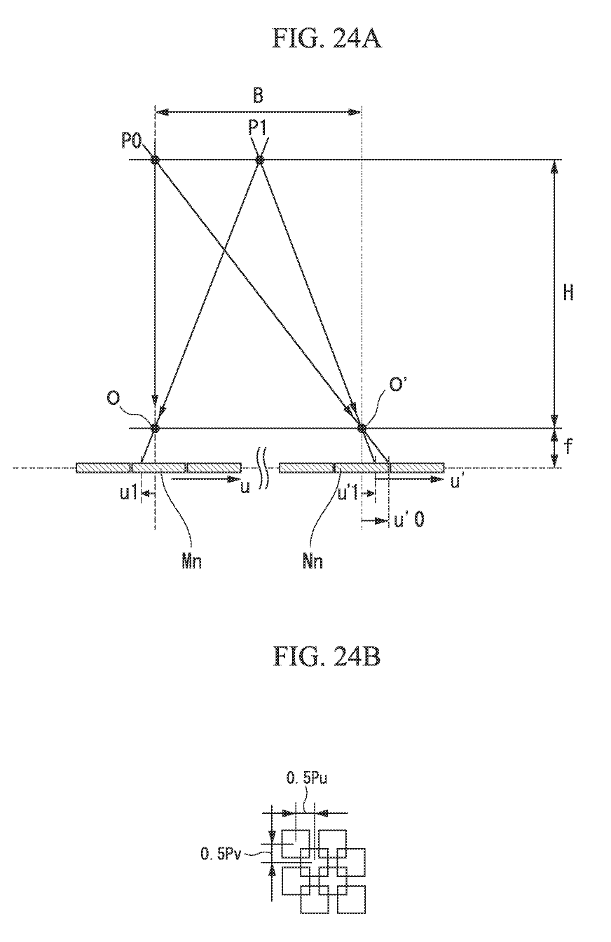

FIG. 24A and FIG. 24B are schematic representations describing the operation of the imaging apparatus 1. FIG. 24A and FIG. 24B show the condition in which imaging is done by an imaging apparatus made of two unit imaging units. In FIG. 24A, the reference symbol Mn indicates a pixel of the imaging element M, and the reference symbol Nn indicates a pixel of the imaging element N.

For the purpose of these description, each of the imaging elements is shown magnified to a pixel unit. The plane of the imaging element is defined in the two dimensions u and v, and FIG. 24A corresponds to a u-axis cross-section. The imaged objects P0 and P1 are at the same imaging distance H. The image of P0 is formed at u0 and u′0, these being the distances on the imaging elements, taking each of the optical axes as the reference. In FIG. 24A, because P0 is on the optical axis of the imaging element M, u0=0. The images of P1 are at distances of u1 and u1′ from the optical axes. In this case, the relative phase with respect to the pixel of the imaging elements M and N of the positions of the images of P0 and P1 formed on the imaging elements M and N will affect the image shift performance. This relationship is determined by the imaging distance H, the focal length f, and the baseline length B that is the distance between the imaging element optical axes.

In FIG. 24A and FIG. 24B, the positions at which the mutual images are formed, that is, u0 and u0′, are shifted by just half of the size of the pixel. u0 (=0) is positioned at the center of the pixel of the imaging element M. In contrast, u′0 is imaged in the area surrounding the pixel of the imaging element N. That is, there is an offset of one-half the pixel size. In the same manner, u1 and u′1 are shifted by one-half the pixel size. FIG. 24B is a schematic representation of the operation for reproducing and generating one image by performing operations on the same images that were imaged. Pu indicates the pixel size in the u direction, and Pv indicates the pixel size in the v direction. In FIG. 24B, the regions shown by the rectangles are pixels. In FIG. 24B, the relationship is one in which there is a mutual shift of one-half a pixel, this being the ideal condition in which image shifting is done in order to generate a high-definition image.

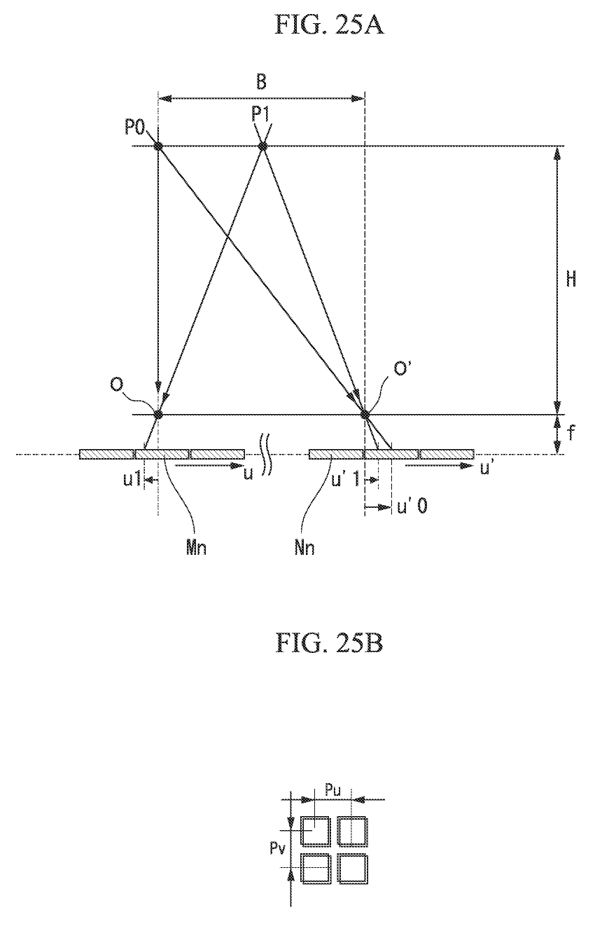

FIG. 25A and FIG. 25B are schematic representations showing the case in which, in contrast to FIG. 24A and FIG. 24B, because of, for example, mounting error, the imaging element N is mounted with an offset that is one half of the pixel size offset from the design.

In FIG. 25A, the reference symbol Mn indicates a pixel of the imaging element M, and the reference symbol Nn indicates a pixel of the imaging element N.

In FIG. 25B, the regions shown by rectangles are pixels. Reference symbol Pu indicates the pixel size in the u direction, and the reference symbol Pv indicates the pixel size in the v direction.

In this case, the mutual relationship between u1 and u′1 is that the phase is the same for the pixels of each of the imaging elements. In FIG. 25A, both images are formed with a shift to the left side with respect to the pixel. The relationship of u0(=0) and u′0 is the same. Thus, there is substantial mutual coincidence of phase, as in FIG. 25B.

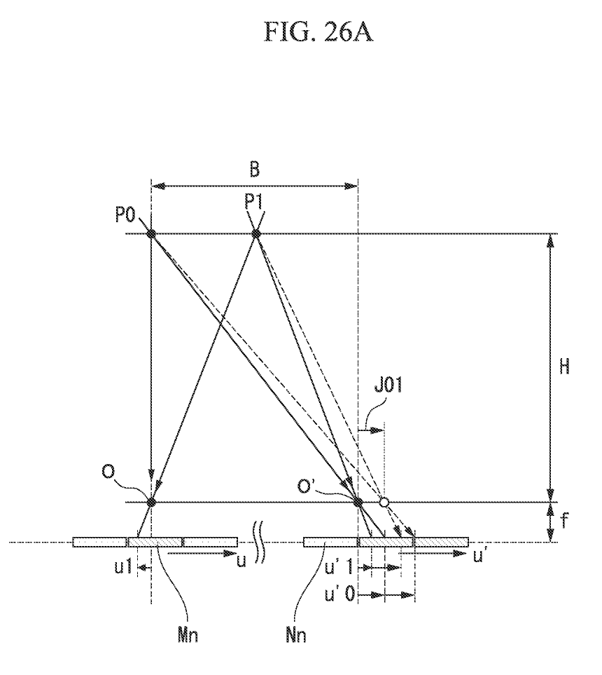

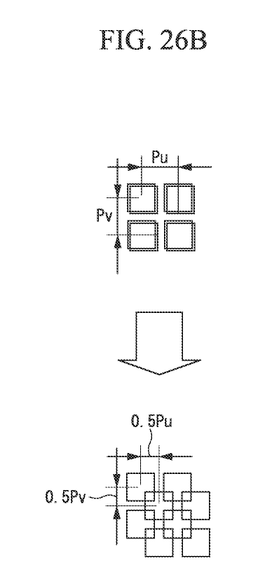

FIG. 26A and FIG. 26B are schematic representations of the case in which, in contrast to FIG. 25A and FIG. 25B, the optical axis shift of the present embodiment is performed.

In FIG. 26A, the reference symbol Mn indicates a pixel of the imaging element M, and the reference symbol Nn indicates a pixel of the imaging element N.

In FIG. 26B, the regions shown by rectangles are pixels. Reference symbol Pu indicates the pixel size in the u direction, and the reference symbol Pv indicates the pixel size in the v direction.

The rightward movement of the pinhole O′ that is the optical axis shift J01 in FIG. 26A provides an image of the operation. In this manner, by using an optical axis shift means to shift the pinhole O′, it is possible to control the position of imaging of the imaged object with respect to the pixel of imaging element. By doing this, it is possible to achieve the ideal phase relationship such as shown in FIG. 26B.

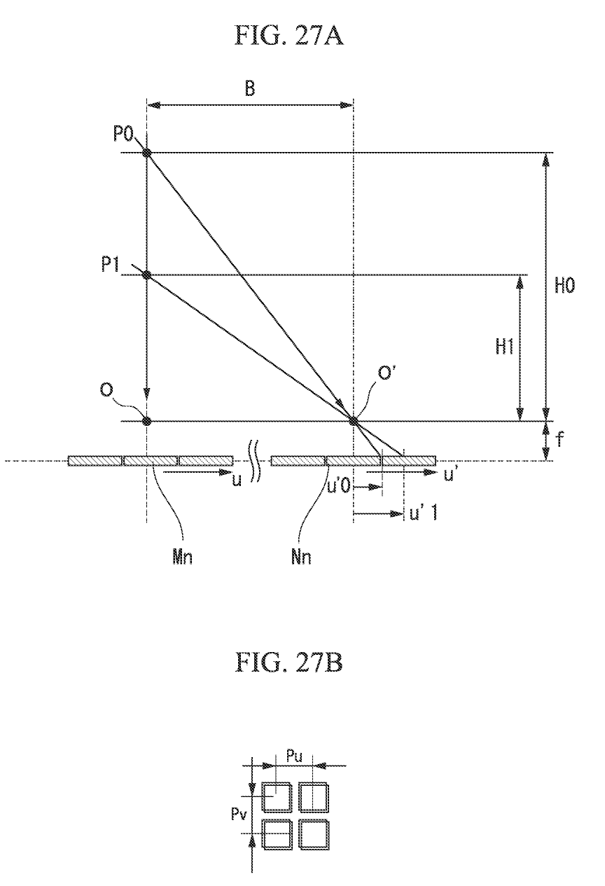

Next, referring to FIG. 27A and FIG. 27B, the relationship between the imaging distance and the optical axis shift will be described.

In FIG. 27A, the reference symbol Mn indicates a pixel of the imaging element M, and the reference symbol Nn indicates a pixel of the imaging element N.

In FIG. 27B, the regions shown by rectangles are pixels. Reference symbol Pu indicates the pixel size in the u direction, and the reference symbol Pv indicates the pixel size in the v direction.

FIG. 27A and FIG. 27B are schematic representations describing the case in which, from the condition in which P0 is imaged at an imaging distance of H0, the photographed object is switched to the object P1 at a distance of H1. In FIG. 27A, because P0 and P1 are each assumed to be on the optical axis of imaging element M, u0=0 and u1=0. Take note of the relationship between the pixels of the imaging element B and the images of P0 and P1 when P0 and P1 are imaged onto the imaging element N. P0 is imaged at the center of the pixel of the imaging element M. In contrast, at the imaging element N, the imaging is in the area surrounding the pixel. Thus, it can be said that this is the optimal phase relationship when P0 is imaged. FIG. 27B is a schematic representation showing the mutual positional relationship between the imaging elements for the case in which the photographed object is P1. As is shown in FIG. 27B, after changing the photographed object to P1, the mutual phases are substantially coinciding.

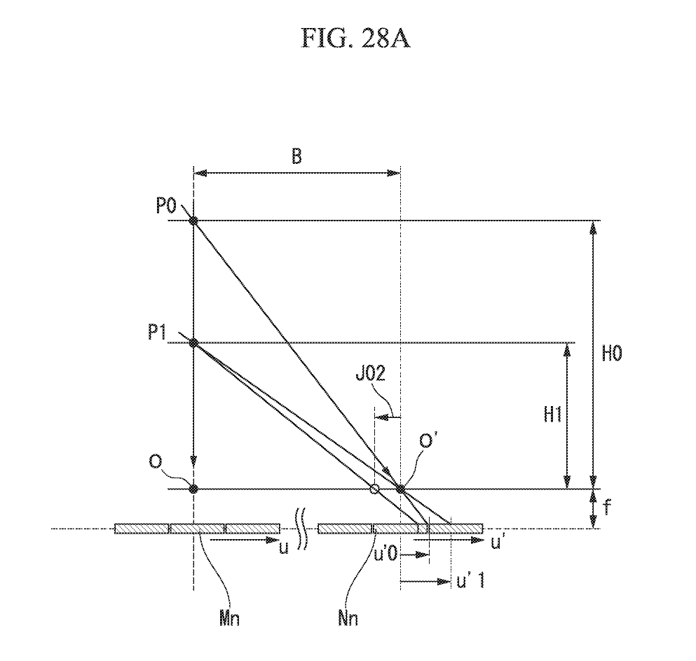

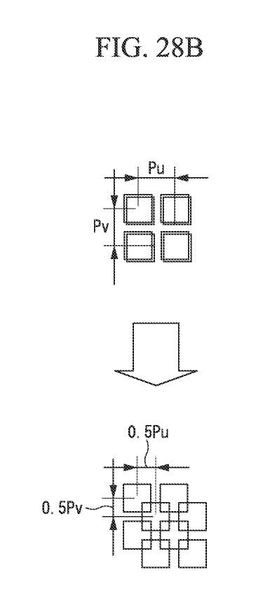

Given this, as shown by the reference symbol J02 in FIG. 28A, by moving the optical axis using an optical axis shift means when imaging the photographed object P1, it is possible to control to the ideal phase relationship such as shown in FIG. 28B, and possible to achieve a high-definition by image shifting.

In FIG. 28B, the reference symbol Mn indicates a pixel of the imaging element M, and the reference symbol Nn indicates a pixel of the imaging element N.

In FIG. 28B, the regions shown by rectangles are pixels. Reference symbol Pu indicates the pixel size in the u direction, and the reference symbol Pv indicates the pixel size in the v direction.

In order to obtain imaging distance information, a rangefinding means that measures the distance may separately provided, or the imaging apparatus of the present embodiment may measure the distance. There are many examples, in surveying, for example, in which a plurality of cameras (unit imaging units) are used to measure a distance. The distance-measurement performance thereof is proportional to the baseline length, which is the distance between cameras, and to the camera focal length, and inversely proportional to the distance to the object to which the distance is being measured.

The imaging apparatus of the present embodiment has, for example, a eight-eye configuration, that is, has a constitution with eight unit imaging units. In the case in which the measured distance, that is, the distance to the photographed object, is 500 mm, imaging is done by four cameras of the eight-eye camera that have mutual optical axis distances (baseline lengths) that are short, image shift processing is assigned, and the distance to the photographed object is measured by the remaining four cameras, which have a long baseline length. In the case in which the distance to the photographed object is a long distance of 2000 mm, the eight eyes are used and image-shift high-resolution processing is performed. In the case of measuring distance, the resolution of an imaged image is, for example, analyzed to judge the amount of defocusing, and processing is performed to estimate the distance. As described above, even in the case in which the distance to the photographed object is 500 mm, the distance measurement accuracy may be improved by alternatively using, for example, another rangefinding means, such as TOF (time of flight).

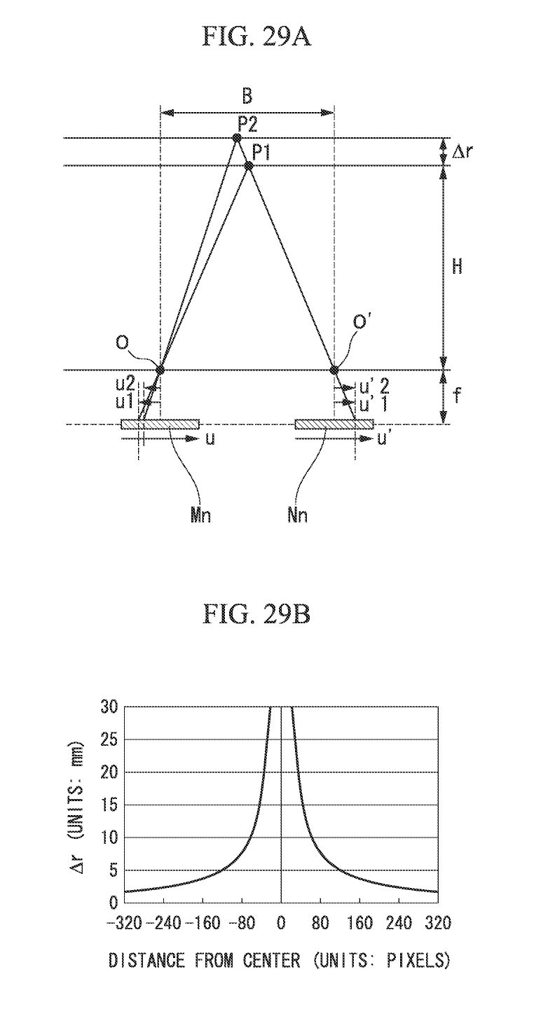

Next, an effect of the image shift by a depth and optical axis will be described, referring to FIG. 29A and FIG. 29B.

In FIG. 29A, the reference symbol Mn indicates a pixel of an imaging element M, and the reference symbol Nn indicates a pixel of an imaging element N.

In FIG. 29B, the horizontal axis indicates a distance (unit: pixel) from the center, and the vertical axis indicates Δr (units: mm).

FIG. 29A is a schematic representation showing a case in which P1 and P2 are captured as images, with the depth Δr being considered. The difference between the distances from the each of the optical axis (u1−u2) is given by the equation (22).

(u1−u2)=Δr×u1/H (22)

In the above, u1−u2 denotes a value determined by the baseline length B, the imaging distance H, and the focal length f. These conditions B, H and f are fixed and treated as constants. They are assumed to be in an ideal optical axis relationship using an optical axis shifting means. The relationship between Δr and the position of the pixel (the distance from the optical axis of an image formed onto the imaging element) is given by the equation (23).

Δr=(u1−u2)×H/u1 (23)

That is, Δr is inversely proportion to u1. Also, in FIG. 29B shows the example of assuming the case in which the pixel size of 6 μm, the imaging distance of 600 mm, and the focal length of 5 mm, in which the influence of the depth falls within a range of one pixel is derived. In the condition in which the influence of depth falls within the range of one pixel, it is possible to achieve a sufficient soft image can be sufficiently obtained. For this reason, for example, an angle of view is narrowed, if the usage is selected depending on the application, it is possible to avoid the deterioration of the soft image performance caused by a depth.

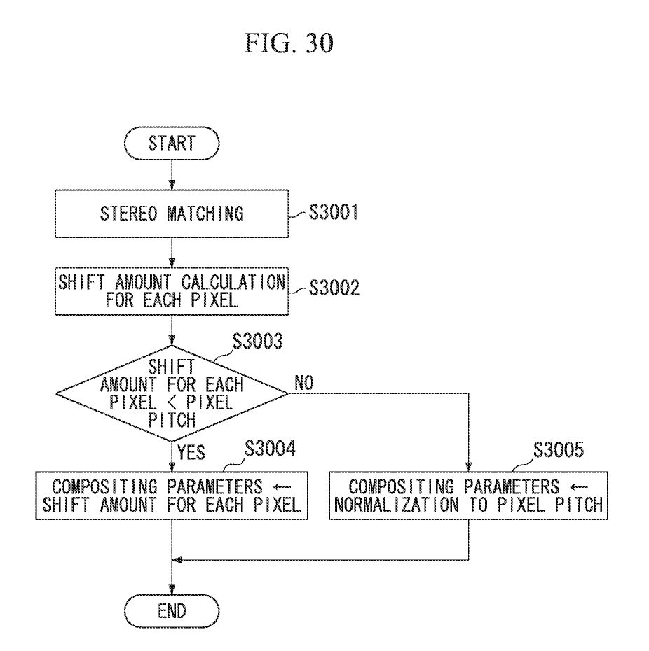

As shown in FIGS. 29A and 29B, in the case in which Δr is small (a shallow depth of field), high-definition processing may be done by applying the same image shift amounts within one screen. The case in which Δr is large (a deep depth of field) will be described, referring to FIG. 27A, FIG. 27B, and FIG. 30. FIG. 30 is a flowchart showing the processing operation of the stereo image processing unit 704 shown in FIG. 10. In FIG. 27A and FIG. 27B, an offset in the sampling phase by pixels of a plurality of imaging elements having a certain baseline length varies in accordance with the imaging distance. For this reason, in order to achieve high definition at any imaging distance, it is necessary to vary the image shift amounts in accordance with the imaging distance. For example, if the photographed object has a large depth, even if there is optimal phase difference at a certain distance, the phase difference is not optimal in another distance. That is, it is necessary to vary the shift amounts for each pixel. The imaging distance and the movement amounts of a point that forms an image on an imaging element are represented by the equation (24).

u0−u1=f×B×((1/H0)−(1/H1)) (24)

The stereo image processing unit 704 (refer to FIG. 10) determines data normalized to the shift amounts for the each pixel (shift parameter for the each pixel) and the pixel pitch of the imaging element. The stereo image processing unit 704 performs stereo matching processing using two imaged images which are compensated based on a predetermined camera parameter (step S3001). A corresponding feature point in a picture is determined by stereo matching, and this calculates the shift amounts (shift parameter for each pixel) (step S3002). Next, the stereo image processing unit 704 compares the shift amounts for each pixel (shift parameter for each pixel) with the pixel pitch of the imaging element (step S3003). As results of this comparison, if the shift amount for each pixel is smaller than the pixel pitch of the imaging element, the shift amount for each pixel is used as compositing parameters (step S3004). On the other hand, if the shift amount for each pixel is larger than the pixel pitch of the imaging element, data normalized to the pixel pitch of the imaging element is determined to be used as compositing parameters (step S3005). Video compositing is performed based on the compositing parameters which are determined at this step, thereby enabling the achievement of a high-definition image without dependence on the imaging distance.

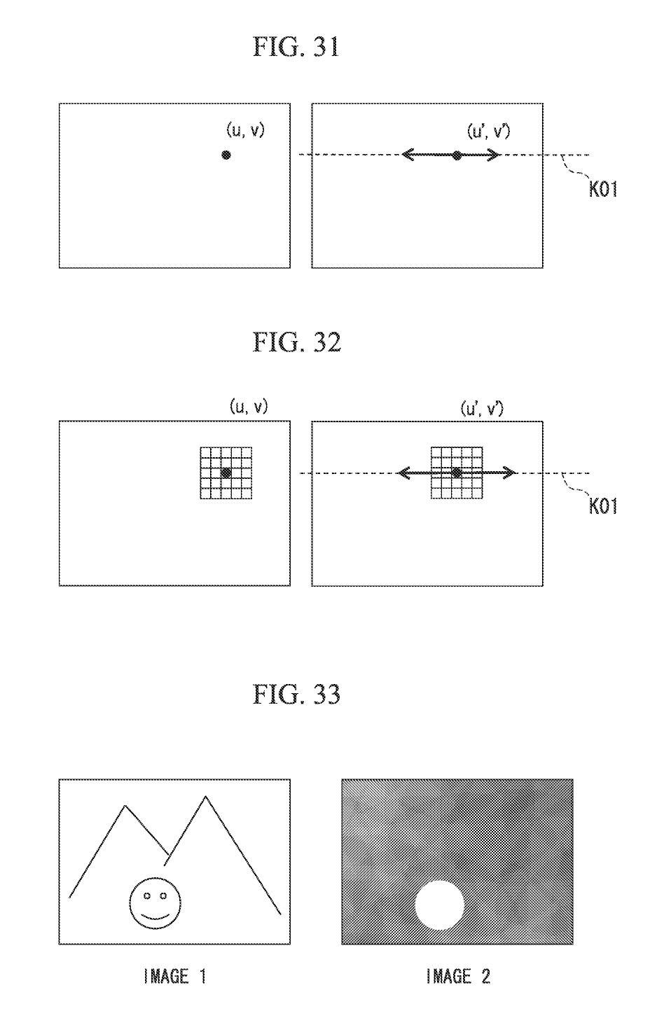

Stereo matching will now be described. Stereo matching indicates processing which is for searching from among other images, using one image as a reference, for a projected point of the same spatial points with respect to the pixels in the position within the image (u, v). Camera parameters required for a camera projection model are determined beforehand by camera calibration. For this reason, it is possible to limit the searching for a corresponding point to a straight line (epipolar line). In particular, as in the present embodiment, in which the optical axis of each unit of an imaging part is set to be parallel, as shown in FIG. 31, an epipolar line K01 is a straight line on the same horizontal line.

As described above, because a corresponding point on another image with respect to the reference image is limited to a point on the epipolar line K01, in stereo matching it is sufficient to search only on the epipolar line K01. This is important for reducing matching errors and for processing at high speed. The rectangle at the left side of FIG. 31 indicates a reference image.

Area-based matching, and feature-based matching or the like exist as a specific searching methods. Area-based matching, as shown in FIG. 32, determines a corresponding point using a template. The rectangle at the left side of FIG. 32 indicates a reference image.

Feature-based matching extracts feature points such as edges or corners of each image so as to determine the correspondence of the feature points to each other.

A method known as a multi-baseline stereo system exists as a method for more accurately determining a corresponding point. This is a method that uses multiple stereo image pairs using more cameras rather than using a stereo matching by one pair of cameras. Stereo images are obtained using pairs of stereo cameras having baselines with various lengths and directions with respect to a reference camera. If each of the parallaxes in a plurality of image pairs in the case, for example, of parallel stereo, is divided by each baseline length, values corresponding to length in the depth direction are obtained. Therefore, information of stereo matching obtained from each stereo image pair, specifically, a evaluation function, such as an SSD (sum of squared differences) which represents the preciseness of correspondence with respect to each parallax/baseline length, is added together, thereby determining the corresponding position with greater accuracy. That is, if the change of the SSSD (sum of SSD) which is the sum of the SSD with respect to each parallax/baseline length is investigated, a clearer minimum value appears. For this reason, a correspondence error of stereo matching can be reduced, and the precision of estimation can also be increased. Additionally, in multi-baseline stereo, it is also possible to reduce an occlusion problem, in which a part which is visible by a certain camera might not be visible due to hiding in the shadow of object.

FIG. 33 describes an example of a parallax image. The image 1 in FIG. 33 is an original image (reference image), and the image 2 in FIG. 33 is a parallax image resulting from determining the parallax with respect to each pixel of the image 1 in FIG. 33. In the parallax image, the higher the brightness of the image is, the larger is the parallax, that is, the nearer is the imaged object to the camera. Also, the lower the brightness of image is, the smaller the parallax, that is, the father is the imaged object from the camera.

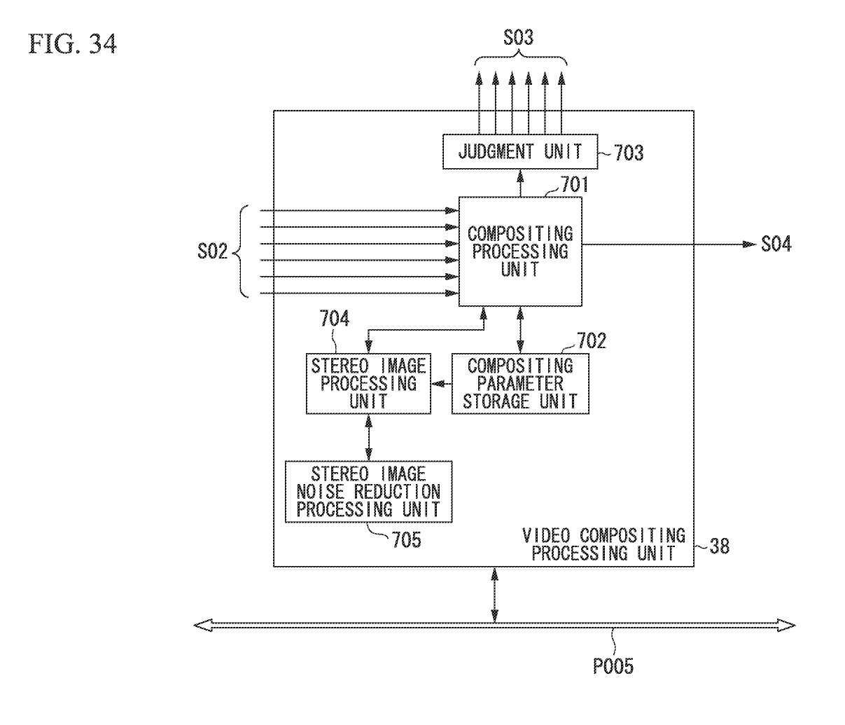

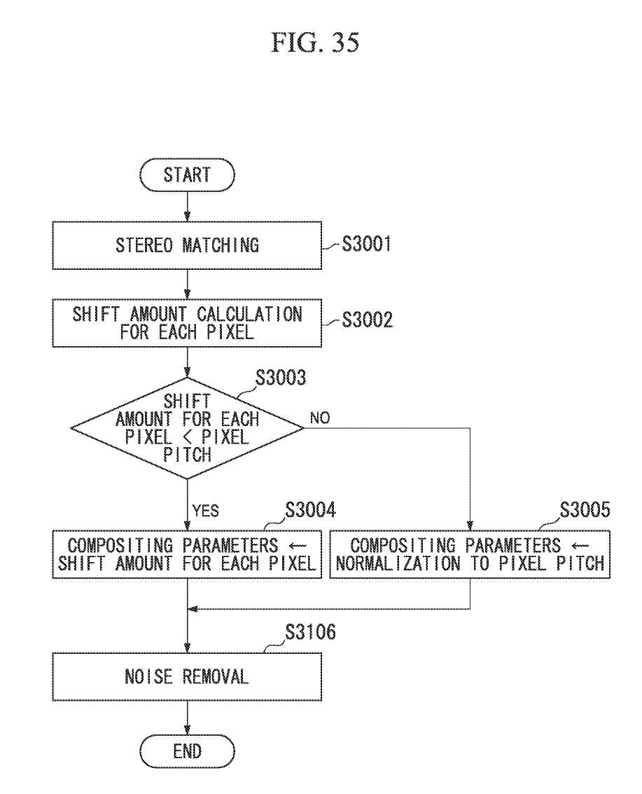

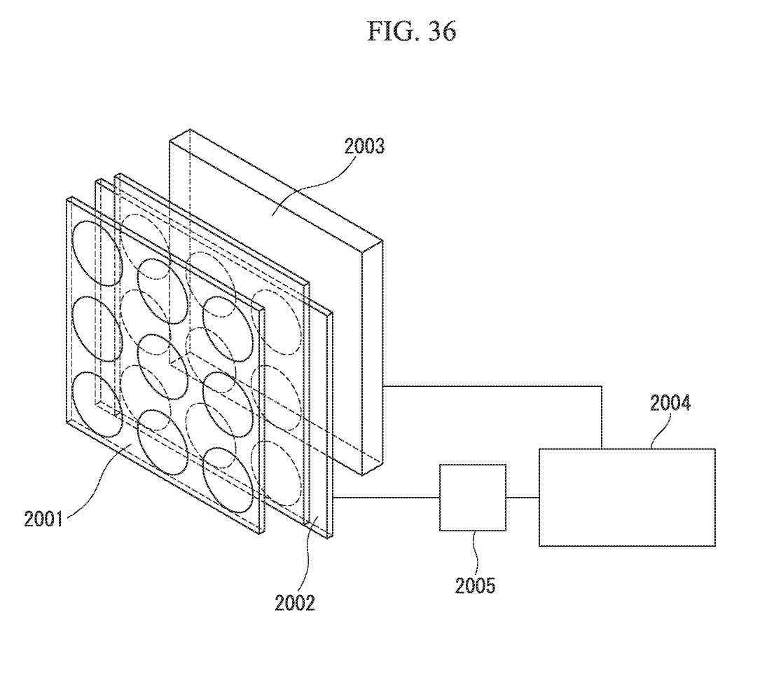

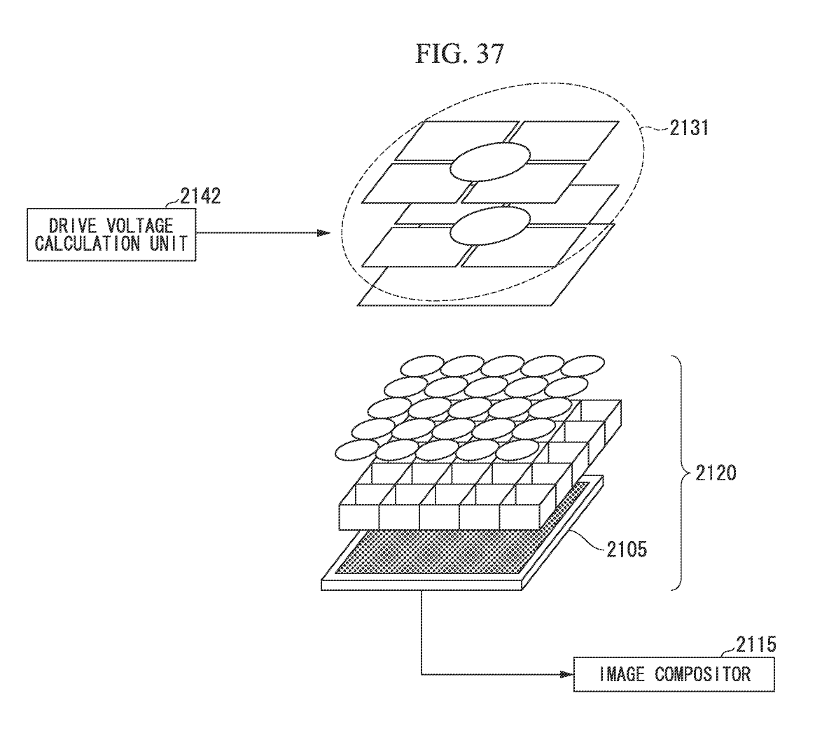

Next, noise reduction in stereo image processing will be described, referring FIG. 34. FIG. 34 is a block diagram showing a constitution of a video compositing processing unit 38 for the case in which noise reduction is performed in the stereo image processing. The point of difference of the video compositing processing unit 38 shown in FIG. 34 with respect to the video compositing processing unit 38 shown in FIG. 10 is that a stereo image noise reduction processing unit 705 is provided. The operation of the video compositing processing unit 38 shown in FIG. 34 will be described, referring to a flowchart of the processing operation of noise reduction in the stereo image processing shown in FIG. 35. In FIG. 35, the processing operation in steps S3001 to S3005 is the same as steps S3001 to S3005 performed by the stereo image processing unit 704 as shown in FIG. 30. In the case in which shift amounts of compositing parameter for each pixel, which is determined in step S3105, are values which differ greatly from the shift amounts of adjacent surrounding compositing parameters, the stereo image noise reduction processing unit 705 performs the noise reduction by replacement by the most frequent value of shift amount of an adjacent pixel (step S3106).

Referring again to FIG. 33, the operation of reducing the amount of processing will be described. Processing to achieve high definition of an entire image is usually performed using a compositing parameter which is determined by the stereo image processing unit 704. However, for example, by performing processing to achieve high-definition on only the face part of the image 1 in FIG. 33 (high-brightness part of the parallax image) but not on the mountain part of the background (a low-brightness part of the parallax image), it is possible to reduce the amount of processing. This processing to achieve high definition, as described above, can also be done by extracting the part of the image that includes the face (a part in which the distance is short and the brightness of the parallax image is high) from the parallax image, and using the image data of the image part and the compositing parameters determined by the stereo image processing unit. Because this reduces the power consumption, it is effective in a portable device which operates by a battery or the like.

As described above, it is possible to composite an image signal obtained by separate imaging apparatus into a high-definition video using optical axis shift control of the liquid-crystal lens. Also, because crosstalk on the imaging elements causes deterioration of image quality, high definition was conventionally difficult. However, according to the imaging apparatus of the present embodiment, the optical axes of light beams incident to the imaging elements are controlled, thereby eliminating crosstalk, and it is possible to achieve an imaging apparatus which can obtains high image quality. Also, because a conventional imaging apparatus captures an image formed on the imaging elements by an image processing, it is necessary to enlarge the resolution of the imaging element to larger than the required imaging resolution. The imaging apparatus according to the present embodiment, however, can perform control to set not only the direction of the optical axis of a liquid-crystal lens, but also to set the optical axis of the light beams incident to the imaging elements at a random position. For this reason, it is possible to minimize the size of the imaging elements, thereby enabling incorporation into a portable terminal or the like, which requires compactness and compactness. It is possible to generate a high-definition two-dimensional image of high image quality without regard to the object distance. Also, it is possible to remove noise due to stereo matching and to perform processing to achieve high definition processing at a high speed.

### INDUSTRIAL APPLICABILITY

The present invention is applicable to an imaging apparatus and the like that can generate a high-definition two-dimensional image of high image quality, without regard to the stereo image parallax, that is, without regard to the object distance.

### REFERENCE SYMBOLS

1 . . . Imaging apparatus,
2 to 7 . . . Unit imaging unit,
8 to 13 . . . Imaging lens,
14 to 19 . . . Imaging element,
20 to 25 . . . Optical axis,
26 to 31 . . . Video processing unit,
32 to 37 . . . Control unit,
38 . . . Video compositing processing unit

1. An imaging apparatus comprising:
a plurality of imaging elements;
a plurality of solid lenses that form images on the plurality of imaging elements;
a plurality of optical axis control units that control the directions of the optical axes of light that is incident to each of the plurality of imaging elements;
a plurality of video processing units that convert photoelectric converted signals output from each of the plurality of imaging elements to video signals;
a stereo image processing unit that, by performing stereo matching processing based on the plurality of video signals converted by the plurality of video processing units, determines the amount of shift for each pixel, and generates compositing parameters in which the shift amounts that exceed the pixel pitch of the plurality of imaging elements are normalized to the pixel pitch; and
a video compositing processing unit that generates high-definition video by compositing the video signals converted by the plurality of video processing units, based on the compositing parameters generated by the stereo image processing unit.

2. The imaging apparatus according to claim 1 further comprising;
a stereo image noise reduction processing unit that, based on the compositing parameters generated by the stereo image processing unit, reduces the noise of the parallax image used in stereo matching processing.

3. The imaging apparatus according to claim 1 wherein the video compositing processing unit achieves high definition only in a prescribed region, based on the parallax image generated by the stereo image processing unit.

4. An imaging method for generating high-definition video comprising:
controlling the directions of the optical axes of light that is incident to each of the plurality of imaging elements;
converting the photoelectric converted signals output by the plurality of imaging elements into video signals;
by performing stereo matching processing based on the plurality of video signals converted by the plurality of video processing units, determining the amount of shift for each pixel, and generating compositing parameters in which the shift amounts that exceed the pixel pitch of the plurality of imaging elements are normalized to the pixel pitch; and
generating high-definition video by compositing the video signals based on the compositing parameters.

5. The imaging apparatus according to claim 2 wherein the video compositing processing unit achieves high definition only in a prescribed region, based on the parallax image generated by the stereo image processing unit.
